(19) United States
(12) Patent Application Publication
(10) Pub. No.: US 2025/0190903 A1
(43) Pub. Date: Jun. 12, 2025

(54) Systems and Methods Utilizing Machine Vision for Tracking and Assisting an Individual Within a Venue

(71) Applicant: ZEBRA TECHNOLOGIES CORPORATION, Lincolnshire, IL (US)

(72) Inventors: Aditya Singh, London (GB); Alessandro Bay, London (GB)

(21) Appl. No.: 18/535,855

(22) Filed: Dec. 11, 2023

(51) Int. Cl. G06Q 10/0631; G06N 3/0895; G06N 3/09; G06Q 10/087; G06T 5/70; G06T 7/73; G06V 10/25; G06V 10/46; G06V 10/764; G06V 10/94; G06V 20/52

(52) U.S. Cl. CPC G06Q 10/06315; G06N 3/0895; G06N 3/09; G06Q 10/087; G06T 5/70; G06T 7/73; G06V 10/25; G06V 10/46; G06V 10/764; G06V 10/95; G06V 20/52; G06T 2207/30232

(57) ABSTRACT

Systems and methods utilizing machine vision for tracking and assisting an individual within a venue are provided herein. The method tracks a location of an individual associated with a container and detects at least one of the container or at least one object within the container present in captured first image data. The method identifies at least one of the at least one object or a region of interest associated with the container and determines, based on the identification, at least one of a value of at least one attribute of the at least one object or first and second sub-areas of the region of interest. The method determines whether at least one of the value of the at least one attribute is greater than a first threshold or a ratio of the first and second sub-areas is less than a second threshold and generates and transmits a notification to a device based on the determination.

### BACKGROUND

An individual (e.g., a customer, shopper, consumer, etc.) shopping in a venue (e.g., a department store, a grocery store, a wholesale store, a pharmacy, etc.) may require a container (e.g., a cart, a basket, a bin, a platform truck, a hand truck, or a dolly) to shop. For example, an individual may require a container to shop if he/she forgot to or could not procure a container prior to shopping and cannot manually carry one or more selected objects (e.g., a product or item). In another example, an individual may require additional container to shop if a current container is full and/or too heavy to tow or push.

### SUMMARY

In an embodiment, the present invention is a method comprising: including: tracking, by at least one imaging assembly, a location of a user associated with a container; detecting at least one of the container or at least one object within the container present in first image data captured by the at least one imaging assembly; identifying at least one of the at least one object or a region of interest associated with the container; determining, based on the identification, at least one of a value of at least one attribute of the at least one object or a first sub-area and a second sub-area of the region of interest; determining whether at least one of the value of the at least one attribute is greater than a first threshold or a ratio of the first sub-area and the second sub-area is less than a second threshold; and generating and transmitting a notification to a device when at least one of the value of the at least one attribute is greater than the first threshold or the ratio of the first sub-area and the second sub-area is less than the second threshold, the notification being indicative of the location of the user and instructions to the device to navigate to the user based on the location.

In another embodiment, the present invention is a system comprising at least one imaging assembly; a server communicatively coupled to the at least one imaging assembly; and computing instructions stored on a memory accessible by the server, and that when executed by one or more processors communicatively connected to the server, cause the one or more processors to: track, by the at least one imaging assembly, a location of a user associated with a container, detect at least one of the container or at least one object within the container present in first image data captured by the at least one imaging assembly, identify at least one of the at least one object or a region of interest associated with the container, determine, based on the identification, at least one of a value of at least one attribute of the at least one object or a first sub-area and a second sub-area of the region of interest, determine whether at least one of the value of the at least one attribute is greater than a first threshold or a ratio of the first sub-area and the second sub-area is less than a second threshold, and generate and transmit a notification to a device when at least one of the value of the at least one attribute is greater than the first threshold or the ratio of the first sub-area and the second sub-area is less than the second threshold, the notification being indicative of the location of the user and instructions to the device to navigate to the user based on the location.

In still yet another embodiment, the present invention is a tangible, non-transitory computer-readable medium storing instructions, that when executed by one or more processors cause the one or more processors to: track, by at least one imaging assembly, a location of a user associated with a container; detect at least one of the container or at least one object within the container present in first image data captured by the at least one imaging assembly; identify at least one of the at least one object or a region of interest associated with the container; determine, based on the identification, at least one of a value of at least one attribute of the at least one object or a first sub-area and a second sub-area of the region of interest; determine whether at least one of the value of the at least one attribute is greater than a first threshold or a ratio of the first sub-area and the second sub-area is less than a second threshold; and generate and transmit a notification to a device when at least one of the value of the at least one attribute is greater than the first threshold or the ratio of the first sub-area and the second sub-area is less than the second threshold, the notification being indicative of the location of the user and instructions to the device to navigate to the user based on the location.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of the present disclosure implemented in an example environment.

FIG. 2 is a diagram illustrating an example embodiment of a computing device of FIG. 1.

FIG. 3 is a diagram illustrating an example embodiment of an imaging assembly of FIG. 1.

FIG. 4 is a flowchart illustrating processing steps of an embodiment of the present disclosure.

FIG. 5 is a diagram illustrating processing steps 258 and 260 of FIG. 4.

FIG. 6 is a diagram illustrating processing steps 266-272 of FIG. 4.

FIGS. 7A-C are diagrams illustrating an embodiment of the present disclosure.

FIGS. 8A-C are diagrams illustrating another embodiment of the present disclosure.

FIG. 9 is a flowchart illustrating processing steps of another embodiment of the present disclosure.

FIGS. 10A-C are diagrams illustrating another embodiment of the present disclosure.

FIG. 11 is a flowchart illustrating another embodiment of the present disclosure.

FIG. 12 is a flowchart illustrating another embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The embodiments of the present disclosure utilize machine vision and/or machine learning techniques/models in conjunction with camera devices and/or other image sensors, and other similar devices, embedded within or otherwise as part of imaging assemblies which are networked within a venue, e.g., a retail venue or store location, to create intelligent systems and methods to assist one or more individuals within the venue. In various embodiments disclosed herein, one or more imaging assemblic(s) are disposed within a venue. Each of the plurality of sensors may provide a data stream at least partially representative of a movement of at least one target (e.g., an individual, a container, and/or an object). In some embodiments, each of the plurality of sensors may include a video camera, where the data stream includes a video stream capturing the movement of the at least one individual, container, and/or object within the venue.

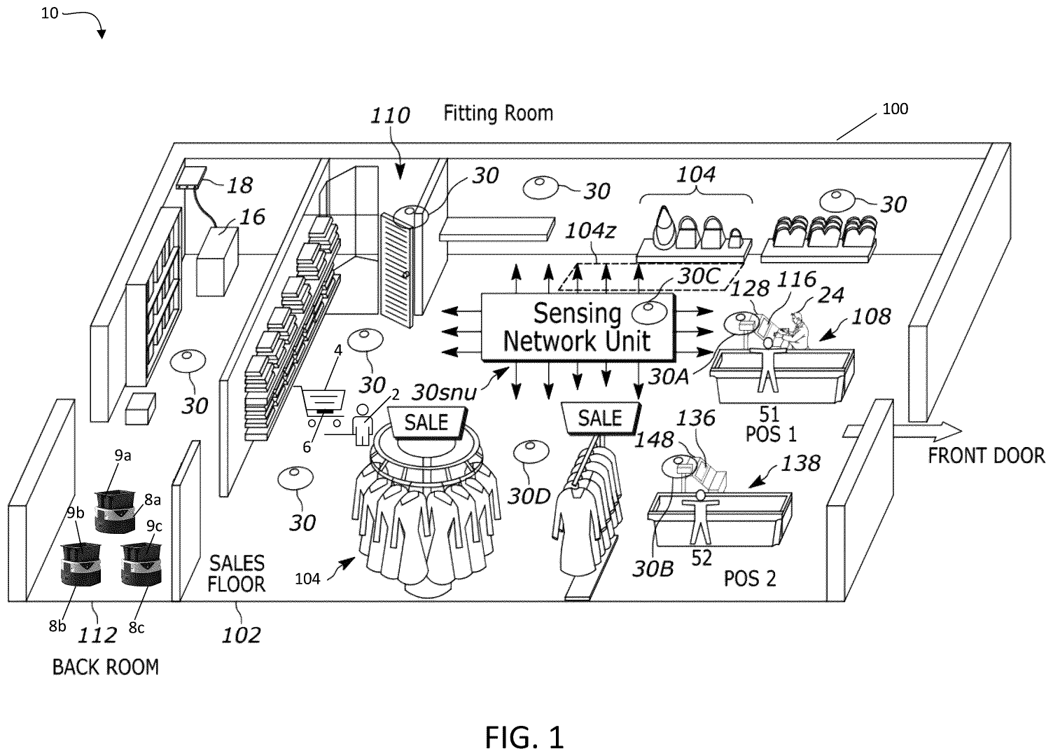

FIG. 1 is a diagram 10 illustrating an embodiment of the present disclosure implemented in an example environment. For example, FIG. 1 illustrates a perspective view of a venue 100 (e.g., a department store) including an individual 2 (e.g., a customer, shopper, consumer, etc.) associated with a container 4 (e.g., a cart) having a sensor 6 (e.g., a load cell or scale); imaging assemblies 30; a back room 112 having a plurality of autonomous mobile robots (AMRs) 8a-c with respective containers 9a-c and a centralized controller 16; a fitting room 110, a sales floor 102 with various objects 104 (e.g., handbags and clothes); and two point of sale (POS) stations 108, 138 having respective POS lanes (e.g., POS lane 1 and POS lane 2).

Each of the POS stations 108, 138 can include various equipment. For example, POS station 108 can include a computer system 116 and an interface 128 that may include, for example, an optical scanner, touchpad, keypad, display, and data input/output interface connecting to the computer system 116. The computer system 116 may be operated by store personnel 24 (e.g., an employee, contract worker, owner, or other operator of the venue 100). POS station 138 can also include a computer system 136 and an interface 148 that may include, for example, an optical scanner, touchpad, keypad, display, and data input/output interface connecting to the computer system 136. In an embodiment, the POS station 138 may not be operated by store personnel and may represent a closed, inactive, or otherwise empty POS lane or station, or, additionally or alternatively, the POS station 138 may constitute a self-checkout (SCO) station.

The POS stations 108, 138 have respective POS lanes (e.g., POS lane 1 and POS lane 2). One or more individual(s) 51 (e.g., a customer, shopper, consumer, etc.) may occupy POS lane 1 where the individual(s) 51 represent customers at POS station 108 checking out, standing in line, and/or interacting with store personnel 24. Additionally or alternatively, one or more individual(s) 52 (e.g., a customer, shopper, consumer, etc.) may occupy or move through POS lane 2 where the individual(s) 52 may represent customers moving through POS lane 2 (e.g., entering or exiting the venue 100, checking out with POS station 138, or otherwise interacting with POS station 138). In an embodiment, POS station 138 may be an SCO station where the computer system 136 is configured to scan objects 104 and accept payment from individuals 2, 51 and 52 for objects 104 brought to POS station 138 and POS lane 2.

The centralized controller 16 may comprise a networked host computer or server. The centralized controller 16 may be connected to one or more AMRs 8a-c, the sensor 6 and one or more imaging assemblie(s) 30 positioned throughout the venue 100 via the network switch 18.

The imaging assemblies 30 can capture image data and communicate the image data to the centralized controller 16 for the detection and identification of targets including, but not limited to, an individual 2, 51, and/or 52 (e.g., a customer, shopper, consumer, etc.), objects 104 (e.g., products or items such as handbags, clothes, etc.) offered for sale on the sales floor 102 and arranged on shelves, hangers, racks, etc., and/or a container 4 (e.g., a cart, a basket, a bin, a platform truck, a hand truck, or a dolly). For example, the imaging assemblic(s) 30 can be positioned throughout the venue 100 to capture image data that is analyzed to detect an individual 2, 51, and/or 52 and detect and identify one or more objects 104 manually carried by the individual 2, 51, and/or 52. In another example, the imaging assemblic(s) 30 can be positioned throughout the venue 100 to capture image data that is analyzed to detect a container 2 and identify a region of interest thereof and/or detect and identify one or more objects 104 within a container 2.

The AMRs 8a-c can respectively include containers 9a-c positioned on a top portion of the AMRs 8a-c. As described in further detail below, the centralized controller 16 can generate and transmit a notification to at least one AMR 8a-c to assist an individual 2, 51 or 52 when an individual 2, 51 or 52 may require a container 9a-c to shop if he/she forgot to or could not procure a container 4 prior to shopping and cannot manually carry one or more selected objects 104. The centralized controller 16 can also generate and transmit a notification to at least one AMR 8a-c to assist an individual 2, 51 or 52 when an individual 2, 51 or 52 may require a container 9a-c to shop if a container 4 is full and/or too heavy to tow or push. The notification can be indicative of a location of an individual 2, 51 or 52 and instructions to navigate to the individual 2, 51 or 52 to provide a container 9a-c.

The centralized controller 16 can identify an object 104 by applying a feature extractor model to image data to generate at least one object 104 descriptor indicative of a feature (e.g., a size, a shape, a color, a height, a width, or a length) of the object 104 and executing a nearest neighbor search within an object database storing one or more known object descriptors corresponding to respective image data of one or more known objects to determine and select a known object corresponding to the object 104 from a ranked list of known objects. Additionally, the centralized controller 16 can determine one or more attributes (e.g., a location, a weight, a price) of an object 104 and values (e.g., integer values) thereof from the identification of the object 104.

The captured image data may be analyzed at the centralized controller 16 or at the computer systems 116 and 136. Thus, in one aspect, the centralized controller 16 may be communicatively coupled to a sensing network unit (snu) 30 snu comprising one or more imaging assemblies as a group. As shown in FIG. 1, the imaging assemblies 30A, 30B, 30C, and 30D are connected to the sensing network unit 30 snu, which is connected to the centralized controller 16. The sensing network unit 30 snu may control the imaging assemblies 30A, 30B, 30C, and/or 30D for specific tracking and/or identification of targets (e.g., an individual 2, 51, and/or 52, objects 104 and/or a container 4) within the venue 100. The imaging assemblie(s) 30 may also be individually connected to a backend host (not shown). Additionally, the sensing network unit 30 snu may control the imaging assemblies 30A, 30B, 30C, and/or 30D to provide navigation guidance to the AMRs 8a-c.

In an embodiment, one or more of the POS stations 108, 138 may have an imaging assembly (not shown) that captures image data at the point of sale. For example, the POS stations 108, 138 may be bi-optic stations, each with one or more imaging assemblies capturing image data over respective fields of view (FOV). Image data captured at the POS stations 108, 138 or other data can be used to detect an individual 2, 51, and/or 52 and detect and identify one or more objects 104 manually carried by the individual 2, 51, and/or 52. Image data captured at the POS stations 108, 138 or other data can also be used or to detect a container 4 and identify a region of interest thereof and/or detect and identify one or more objects 104 within a container 4.

Each of the computer systems 116 and 136 may comprise one or more processors and may be in electronic communication with the centralized controller 16 via the network switch 18. The network switch 18 may be configured to operate via wired, wireless, direct, or networked communication with one or more of the imaging assemblies 30, where the imaging assemblies 30 may transmit and receive wired or wireless electronic communication to and from the network switch 18. The imaging assemblies 30 may also be in wired and/or wireless communication with computer systems 116 and 136. Similarly, each of the imaging assemblies 30 may either be in wired or wireless electronic communication with the centralized controller 16 via the network switch 18. For example, in an embodiment, the imaging assemblies 30 may be connected via Category 5 or 6 cables and use the Ethernet standard for wired communications. In another embodiment, the imaging assemblies 30 may be connected wirelessly, using built-in wireless transceivers, and may use the IEEE 802.11 (WiFi) and/or Bluetooth standards for wireless communications. Other embodiments may include imaging assemblies 30 that use a combination of wired and wireless communication.

The network switch 18 may also be configured to operate via wireless, direct, or networked communication with one or more of the AMRs 8a-c and the sensor 6, where the AMRs 8a-c and the sensor 6 may transmit and receive wireless electronic communication to and from the network switch 18. The AMRs 8a-c and the sensor 6 may also be in wireless communication with computer systems 116 and 136. Similarly, the AMRs 8a-c and the sensor 6 may be in wireless electronic communication with the centralized controller 16 via the network switch 18. The AMRs 8a-c and the sensor 6 may transmit and receive wireless electronic communication using built-in wireless transceivers and may use the IEEE 802.11 (WiFi) and/or Bluetooth standards for wireless communications.

The interfaces 128 and 148 may provide a human/machine interface, e.g., a graphical user interface (GUI) or screen, which presents information in pictorial and/or textual form (e.g., representations of the objects 104). Such information may be presented to the store personnel 24, or to other store personnel such as security personnel (not shown). The computer systems 116, 136 and the interfaces 128, 148 may be separate hardware devices and include, for example, a computer, a monitor, a keyboard, a mouse, a printer, and various other hardware peripherals, or may be integrated into a single hardware device, such as a mobile smartphone, or a portable tablet, or a laptop computer. Furthermore, the interfaces 128, 148 may be in a smartphone, or tablet, etc., while the computer systems 116, 136 may be a local computer, or remotely hosted in a cloud computer. The computer systems 116, 136 may include a wireless RF transceiver that communicates with each imaging assembly 30, AMR 8a-c, and sensor 6 via Wi-Fi or Bluetooth.

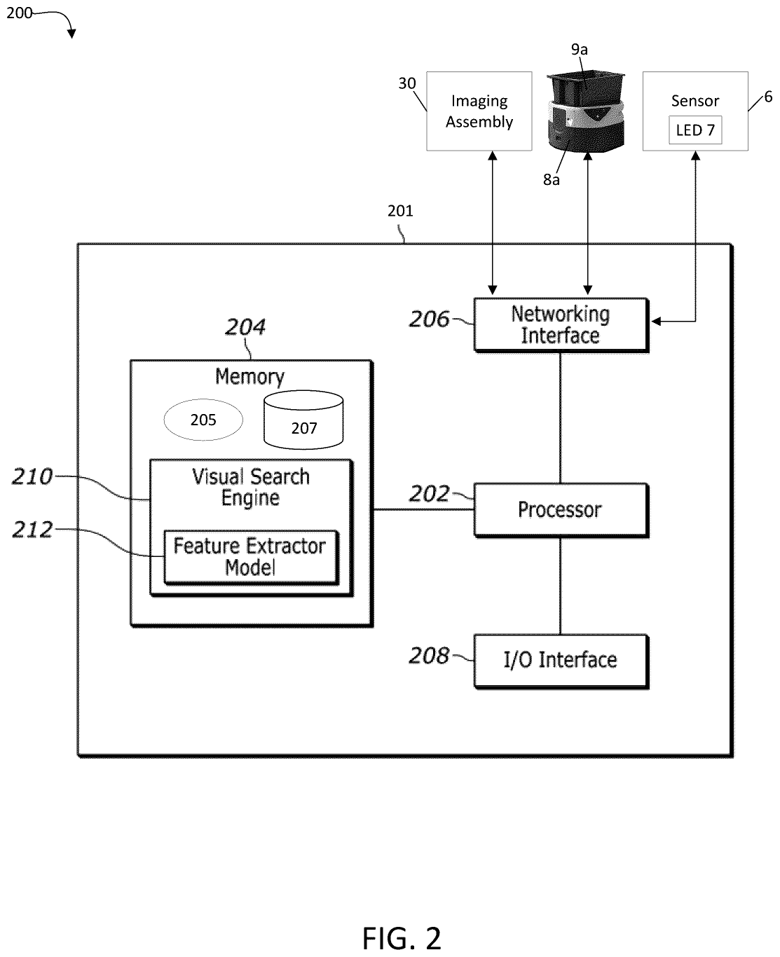

FIG. 2 is a diagram 200 illustrating an example embodiment of a computing device 201 that may be implemented as the centralized controller 16 or the computer systems 116, 136 of FIG. 1. The computing device 201 is configured to execute computer instructions to perform operations associated with the systems and methods as described herein, for example, to implement the example operations represented by the block diagrams or flowcharts of the drawings accompanying this description. The computing device 201 may implement enterprise service software that may include, for example, RESTful (representational state transfer) API services, message queuing service, and event services that may be provided by various platforms or specifications, such as the J2EE specification implemented by any one of the Oracle WebLogic Server platform, the JBoss platform, or the IBM WebSphere platform, etc. In some aspects, the computing device 201 may be located offsite from the venue 100, and be implemented as a cloud-based server. Other example embodiments capable of, for example, implementing operations of the example methods described herein include field programmable gate arrays (FPGAs) and application specific integrated circuits (ASICs).

The computing device 201 includes a processor 202 (e.g., one or more microprocessors, controllers, and/or any suitable type of processor); a memory 204 including an application 205, a database 207, and a visual search engine 210 having a feature extractor model 212; a networking interface 206; and an input/output (I/O) interface 208.

The processor 202 can access (e.g., via a memory controller) the memory 204 (e.g., volatile memory, non-volatile memory), and interacts with the memory 204 to obtain machine-readable instructions stored in the memory 204 corresponding to the operations represented by the flowcharts of this disclosure. It should be understood that each of the processor 202, the memory 204, and/or any other component of the computing device 201 may include and/or otherwise represent multiple processors, memories, components, etc. The processor 202 may be coupled to the memory 204 via a computer bus responsible for transmitting electronic data, data packets, or otherwise electronic signals to and from the processor 202 and the memory 204 to implement or perform the machine readable instructions, methods, processes, elements or limitations, as illustrated, depicted, or described for the various flowcharts, illustrations, diagrams, figures, and/or other disclosure herein.

The memory 204 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. A computer program or computer based product, application 205, or code (e.g., visual search engine 210, feature extractor model 212, and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 202 (e.g., working in connection with the respective operating system in the memory 204) to facilitate, implement, or perform the machine readable instructions, methods, processes, elements or limitations, as illustrated, depicted, or described for the various flowcharts, illustrations, diagrams, figures, and/or other disclosure herein. The program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The memory 204 may include the visual search engine 210 and the feature extractor model 212 that are each accessible by the processor 202. The visual search engine 210 and the feature extractor model 212 may comprise rule-based instructions, an artificial intelligence (AI), machine vision model, and/or machine learning-based model, and/or any other suitable algorithm architecture or combination thereof configured to detect and identify an object 104 based on image data captured by an imaging assembly 30. For example, the processor 202 may access the memory 204 to execute the visual search engine 210 and/or the feature extractor model 212 to query a database 207 to identify an object 104. The feature extractor model 212 may analyze transmitted images and metadata for known objects and objects 104 within a container 4 and/or manually carried by an individual 2 to determine descriptors corresponding to each known object and each object 104 within a container 4 and/or manually carried by an individual 2. The feature extractor model 212 can analyze each image and can characterize each feature identified within the image by a descriptor, as discussed further herein. Each descriptor may be a vector of real numbers that is a numerical interpretation of the feature associated with an object 104 identified within each image. The visual search engine 210 can compare these vectors to determine a metric distance between each pair of vectors that represent the same feature type (e.g., a size, a shape, a color, a height, a width, or a length) of an object 104. For example, the size of a respective object 104 may correspond to a vector of real numbers wherein each numerical value within the vector and/or the aggregate string of numerical values corresponds to an aspect of the size of the respective object 104. The visual search engine 210 may compare each numerical value within the vector in a piecewise fashion and/or compare the aggregate vectors to determine the metric distance between the descriptor vectors for each particular feature type.

Additionally, or alternatively, the database 207 can be configured to receive object images and metadata and may be implemented as and/or communicatively connected to one or more cloud-based servers (not shown), such as a cloud-based computing platform. For example, the database 207 may be connected via a network to any one or more cloud-based platform(s) such as MICROSOFT AZURE, AMAZON AWS, or the like. In an embodiment, the feature extractor model 212 can also be stored on such a cloud-based server, and the database 207 may forward object images and metadata and/or otherwise receive object 104 descriptors from the cloud-based server when the feature extractor model 212 generates the object 104 descriptors.

The visual search engine 210 can query the database 207 to generate a list of known objects and select a known object that most likely corresponds to an object 104 within a container 4 and/or manually carried by an individual 2. For example, the visual search engine 210 can compare features from the images and metadata of these known objects to an image and associated metadata of an object 104 within a container 4 and/or manually carried by an individual 2 to determine a known object that most likely corresponds to an object 104 within a container 4 and/or manually carried by an individual 2. The visual search engine 210 can rank the list of known objects.

Machine-readable instructions corresponding to the example operations described herein may be stored on one or more removable media (e.g., a compact disc, a digital versatile disc, removable flash memory, etc.) that may be coupled to the computing device 201 to provide access to the machine-readable instructions stored thereon. Moreover, the visual search engine 210 and/or the feature extractor model 212 may also be stored in a memory of an imaging assembly 30 and/or in an external database (e.g., a cloud-based server).

The memory 204 may additionally store an operating system (OS) (e.g., Microsoft Windows, Linux, Unix, etc.) capable of facilitating the functionalities, apps, methods, or other software as discussed herein. The memory 204 may also store machine readable instructions, including any of one or more application(s) 205, one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, or otherwise be part of, a machine vision-based imaging application, such as the visual search engine 210 and/or the feature extractor model 212, where each may be configured to facilitate their various functionalities discussed herein. It should be appreciated that one or more other applications may be envisioned and that are executed by the processor 202.

The processor 202 may interface with the memory 204 using the computer bus to execute the OS. The processor 202 may also interface with the memory 204 using the computer bus to create, read, update, delete, or otherwise access or interact with the data stored in the memory 204 and/or external databases (e.g., a relational database, such as Oracle, DB2, MySQL, or a NoSQL based database, such as MongoDB). The data stored in the memory 204 and/or an external database may include all or part of any of the data or information described herein, including, for example, image data captured by an imaging assembly 30 and/or other suitable information.

The networking interface 206 can enable communication with other machines and/or devices including, but not limited to, a sensor 6 having an light emitting diode (LED) 7, AMRs 8a-c having respective containers 9a-c, and imaging assemblies 30 via one or more networks. The networking interface 206 includes any suitable type of communication interface(s) (e.g., wired and/or wireless interfaces) configured to operate in accordance with any suitable protocol(s) (e.g., Ethernet for wired communications and/or IEEE 802.11 for wireless communications). The interface 206 can provide for the central controller 16 to communicate with other components of the venue 100 including, but not limited to, sensor 6, AMRs 8a-c, imaging assemblic(s) 30 and POS station 108 and/or POS station 138. The networking interface 206 may be configured to communicate (e.g., send and receive) data via one or more external/network port(s) to one or more networks or local terminals, described herein. In an embodiment, the networking interface 206 may include a client-server platform technology such as ASP .NET, Java J2EE, Ruby on Rails, Node .js, a web service or online API, responsive for receiving and responding to electronic requests. The networking interface 206 may implement the client-server platform technology that may interact, via the computer bus, with the memory 204 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

In an embodiment, the networking interface 206 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to the network by which, for example, components of the system correspond. In an embodiment, the network may comprise a private network or local area network (LAN). Additionally, or alternatively, the network may comprise a public network such as the Internet. In an embodiment, the network may comprise routers, wireless switches, or other such wireless connection points communicating to an imaging assembly 30, AMRs 8a-c, and/or sensor 6 by wireless communications based on any one or more of various wireless standards, including by non-limiting example, IEEE 802.11a/b/c/g (WIFI), the BLUETOOTH standard, or the like.

The I/O interface 208 can enable receipt of user input and communication of output data to the user, which may include, for example, any number of keyboards, mice, USB drives, optical drives, screens, touchscreens, etc. Generally, the I/O interfaces 208 may include or implement operator interfaces configured to present information to an administrator or operator and/or receive inputs from the administrator or operator. An operator interface may provide a display screen (e.g., by the interfaces 128, 148) which a user/operator may use to visualize any images, graphics, text, data, features, pixels, and/or other suitable visualizations or information.

As mentioned above, in an embodiment, the computer systems 116, 136 (e.g., by the visual search engine 210 and/or the feature extractor model 212) may perform the functionalities as discussed herein as part of a “cloud” network or may otherwise communicate with other hardware or software components within the cloud (e.g., a cloud-based server) to send, retrieve, or otherwise analyze data or information described herein.

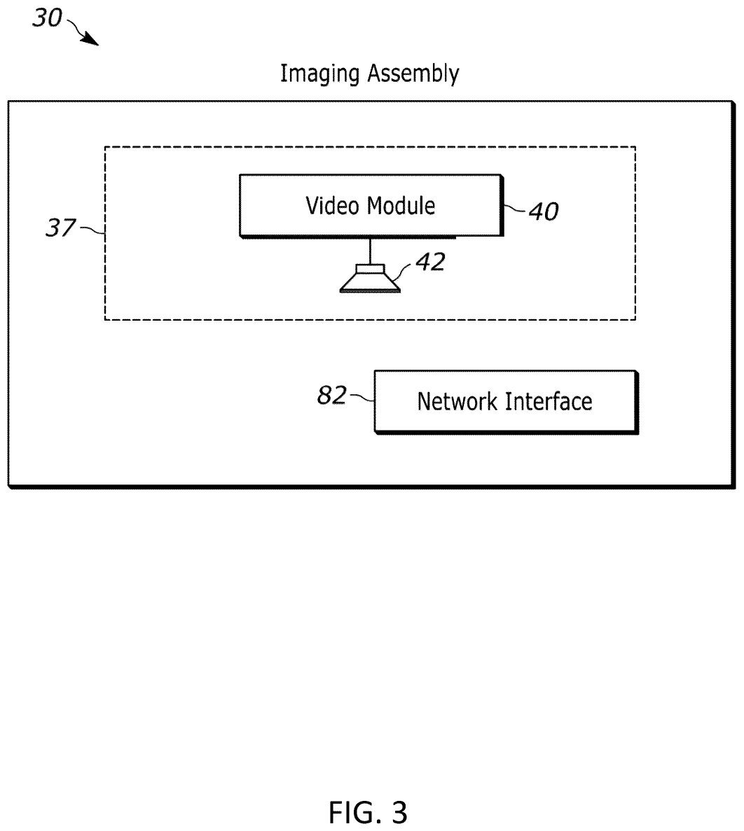

FIG. 3 is a diagram illustrating an example embodiment of an imaging assembly 30 of FIG. 1. An imaging assembly 30 can include a camera 42 (e.g., a digital camera and/or digital video camera) for capturing images and/or frames and data thereof. Each image may comprise pixel data that can be analyzed by one or more components (e.g., the centralized controller 16 and/or the computer systems 116 and 136). The camera 42 can be configured to capture or otherwise generate images and store such images in a memory of a respective device (e.g., the database 207 of the computing device 201 or a cloud-based server).

In an embodiment, an imaging assembly 30 can include a photo-realistic camera (not shown) for capturing, sensing, or scanning two-dimensional (2D) image data. The photo-realistic camera can be a red, green, blue (RGB) based camera for capturing 2D images having RGB-based pixel data. In an embodiment, an imaging assembly can alternatively or additionally include a three-dimensional (3D) camera (not shown) for capturing, sensing, or scanning 3D image data. The 3D camera may include an Infra-Red (IR) projector and a related IR camera for capturing, sensing, or scanning 3D image data/datasets.

In an embodiment, the imaging assembly 30 can further include a video detector 37 operative for detecting and/or locating a target (e.g., an individual 2, 51 and/or 52, a container 4, and/or an object 104) by capturing an image of the target in the venue 100, such as an individual 2 moving through venue 100 with or without a container 4 (e.g., a cart) or an object 104 positioned on a shelf of the venue 100. The video detector 37 can be mounted in each imaging assembly 30 and can include a video module 40 having a camera controller (not shown) that is connected to a camera 42 (e.g., a wide-angle field of view camera) for capturing an image of a target. In an embodiment, the camera 42 can be a high-bandwidth, video camera, such as a moving picture expert group (MPEG) compression camera.

In an embodiment, the camera can include wide-angle capabilities such that camera 42 can capture images over a large area to produce a video stream of the images. As referred to herein, the image capture devices or video cameras (also referred to as image sensors herein) are configured to capture image data representative of the venue 100 or an environment of the venue 100. Further, the image sensors described herein are example data capture devices, and example methods and apparatuses disclosed herein are applicable to any suitable type of data capture device(s). In an embodiment, the images and/or data from the images may be synchronized or fused with other data (e.g., radio frequency identification (RFID) data), and used to further describe, via data, the venue 100 or environment of the venue 100. Such synchronized or fused data may be used, for example, by the centralized controller 16 to make determinations or for other features as described herein. It should be appreciated that the imaging assembly 30 can include any suitable imaging components, and can be configured to capture any suitable type of images.

Each of the imaging assemblies 30 can capture images and/or frames and data thereof and locationing and direction of travel information from its one or more detectors, such as video detector 37 having camera 42. Such information can be used to determine a location and/or direction of travel of a target (e.g., an individual 2, 51 and/or 52, a container 4, and/or an object 104). For example, an imaging assembly 30 can filter captured video to segment and exclude from the captured wide-angle video, images of the target near the target sensing station, as the target moves through the venue 100. This segmentation can result in discarding video images that do not include the target or discarding portions of the wide-angle video that extend beyond an area of interest surrounding and including the target itself.

In an embodiment, focusing, image tilting, and image panning procedures can be determined by performing image processing on the target in the wide-angle video stream. For example, in an embodiment, an imaging assembly 30 may perform target identification procedures over a determined FOV, procedures such as edge detection to identify the target, segmentation to segment out the target's image from other objects 104 in the video stream, and a determination of any translational, rotational, shearing, or other image artifacts affecting the target image and that would then be corrected for before using the captured target image.

Any of the imaging assemblies 30, including alone, together, or some combination thereof, may transmit electronic information, including any image or video, or other information, to the computing device 201 for processing and/or analysis. For example, the computing device 201 of FIG. 2 may include a network communication interface 206 communicatively coupled to network communication interfaces 82 of the imaging assemblies 30 to receive images and/or video stream data. The imaging assemblies 30 may also receive information, commands, or execution instructions, including requests to provide additional sensory or detection information from the computing device 201 to perform the features and functionally as described herein.

In an embodiment, an imaging assembly 30 can also process the 2D image data/datasets and/or 3D image data/datasets for use by other components and/or devices. For example, the imaging assembly 30 can include one or more processors (not shown) to process the image data or datasets captured, scanned, or sensed by the imaging assembly 30 by localizing (e.g., identifying and cropping) an object 104 included within the image data. The processing of the image data may generate post-imaging data that may include metadata, simplified data, normalized data, result data, status data, or alert data as determined from the original scanned or sensed image data. The image data and/or the post-imaging data may be sent to the database 207 or a cloud-based server for further processing, viewing, manipulation, and/or otherwise interaction. In other embodiments, the image data and/or the post-imaging data may be sent to a server for storage or for further manipulation.

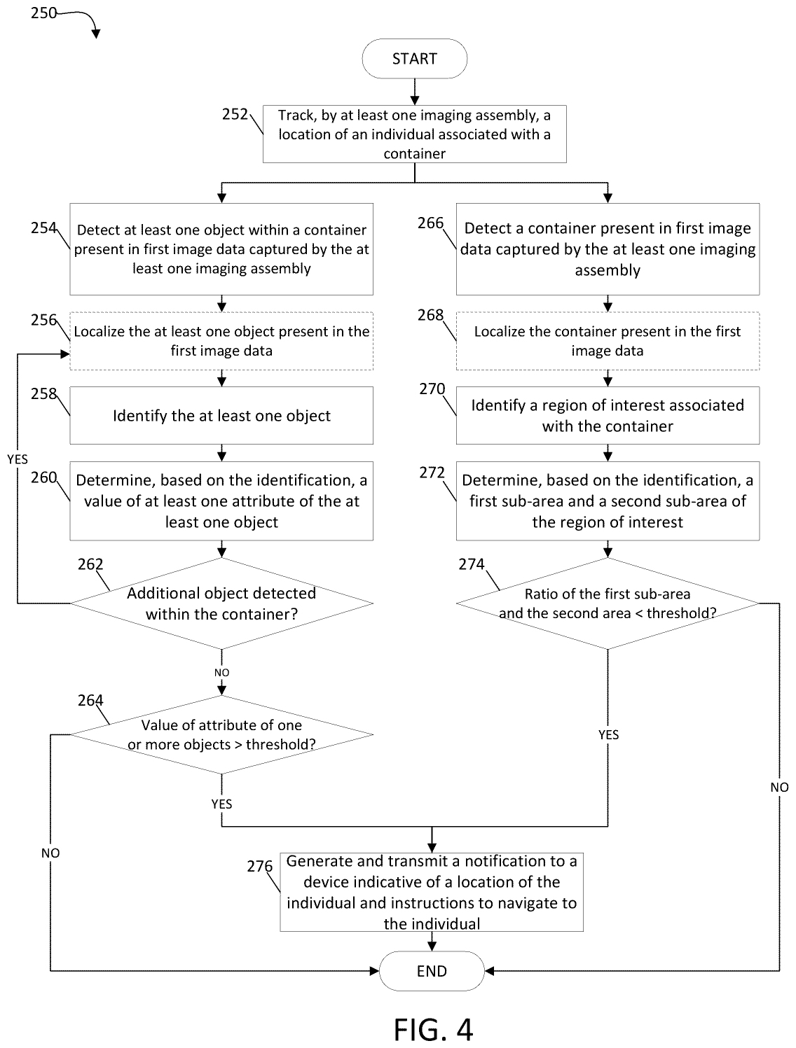

FIG. 4 is a flowchart 250 illustrating processing steps of an embodiment of the present disclosure. Beginning in step 252, the system tracks, by at least one imaging assembly 30, a location of an individual 2 associated with a container 4. The at least one imaging assembly 30 is disposed within a venue 100 and is configured to capture image data over at least a portion of a zone within the venue 100. The container 4 can include, but is not limited to, a cart, a basket, a bin, a platform truck, a hand truck and a dolly. Additionally, the container 4 can include a sensor 6 (e.g., a load cell or scale) having an LED 7.

The process then proceeds to steps 254-264 or steps 266-274. It should be understood that the system can also execute steps 254-264 and steps 266-274 in parallel. In step 254, the system detects at least one object 104 within a container 4 present in image data captured by the at least one imaging assembly 30. In step 256, the system optionally localizes the at least one object 104 present in the image data. For example, the system can crop the at least one object 104 from the image data and/or remove background noise from the image data.

Then, in step 258, the system identifies the at least one object 104. The system can identify the at least one object 104 by utilizing a feature extractor model 212 to generate at least one object 104 descriptor, and a visual search engine 210 to search a database 207 and select from the database 207 a known object based on the at least one object 104 descriptor. The system can generate at least one object 104 descriptor indicative of one or more features (e.g., a size, a shape, a color, a height, a width, or a length) of the detected at least one object 104 by applying a feature extractor model 212 to the image data. The feature extractor model can be a machine learning model comprising a convolutional neural network (CNN) classifier or a visual transformer classifier trained to classify a given object 104 based on image data of the given object 104. It should be understood that the feature extractor model can be any applicable machine learning model and can comprise any applicable network and/or classifier. Further, it should be understood that the machine learning model can train on a variety of tasks including, but not limited to, supervised learning tasks (e.g., detection, classification, segmentation, or the like) or unsupervised learning tasks (e.g., self-supervised learning, metric learning, or the like), or a combination of both.

Additionally, the system can execute, via a visual search engine 210, a nearest neighbor search within a database 207 storing one or more known object descriptors corresponding to respective image data of one or more known objects to determine a respective metric distance between the at least one object 104 descriptor and the one or more known object descriptors. The database 207 can also store, for each known object represented, at least one attribute of the known object including, but not limited to, a known object location (e.g., within a venue 100), a known object weight, and a known object volume. Further, the system can select, via the visual search engine 210, a known object corresponding to the detected at least one object 104 from a ranked list of known objects where the ranked list of known objects is prioritized based on a respective metric distance between the at least one object 104 descriptor and the one or more known object descriptors. The at least one object 104 descriptor and the one or more known object descriptors are indicative of one or more features including, but not limited to, a size, a shape, a color, a height, a width, or a length of an object 104 and one or more known objects. Additionally, the at least one object 104 descriptor and the one or more known object descriptors correspond to vectors and the respective metric distance between the at least one object 104 descriptor and the one or more known object descriptors corresponds to differences between respective vectors of the at least one object 104 descriptor and the one or more known object descriptors.

In step 260, the system determines, based on the identification of the at least one object 104, a value of at least one attribute of the at least one object 104. As mentioned above, the database 207 can also store, for each known object represented, at least one attribute of the known object including, but not limited to, a known object location (e.g., within a venue 100), a known object weight, and a known object volume. As such, the system can determine, for example, at least one of a location of the object 104, a weight of the object 104, and a volume of the object 104.

The process then proceeds to step 262. In step 262, the system determines whether an additional object 104 is detected within the container 4. If the system determines that an additional object 104 is detected within the container 4, then the process returns to step 256. If the system determines that an additional object 104 is not detected within the container 4, then the process proceeds to step 264. In step 264, the system determines whether a value of an attribute of one or more objects 104 is greater than a threshold. In this way, the system can determine whether an individual 2 requires an additional container (e.g., containers 9a-c) based on a weight of an object 104 or an aggregate weight of objects 104 within a current container 4. If the system determines that a value of an attribute of one or more objects 104 is greater than a threshold, then the process proceeds to step 276 (discussed in further detail below). For example, the system can determine that an aggregate weight of one or more objects 104 is greater than a threshold. Alternatively, if the system determines that a value of an attribute of one or more objects 104 is less than a threshold, then the process ends. For example, the system can determine that an aggregate weight of one or more objects 104 is less than a threshold.

Returning to step 266, the system detects a container 4 present in image data captured by at least one imaging assembly 30. Then, in step 268, the system optionally localizes the container 4 present in the image data. For example, the system can crop the container 4 from the image data and/or remove background noise from the image data. In step 270, the system identifies a region of interest associated with the container 4. The region of interest can correspond to a shape including, but not limited to, a square, a circle, a rectangle, a parallelogram, and a trapezoid, resembling the container 4. Then, in step 272, the system determines, based on the identified region of interest, a first sub-area and a second sub-area of the region of interest where the first sub-area is indicative of non-occupied space within the container 4 and the second sub-area is indicative of occupied space within the container 4.

In step 274, the system determines whether a ratio of the first sub-area to the second sub-area is less than a threshold. In this way, the system can determine whether an individual 2 requires an additional container (e.g., containers 9a-c) based on an availability of space in a current container 4. If the system determines that the ratio of the first sub-area to the second sub-area is not less than a threshold, then the process ends. Alternatively, if the system determines that the ratio of the first sub-area to the second sub-area is less than the threshold, then the process proceeds to step 276. Alternatively, in an embodiment, the system can determine a ratio of the second sub-area to the first sub-area and a corresponding threshold comparison analysis based on the determined ratio.

In step 276, the system generates and transmits a notification to at least one device (e.g., AMRs 8a-c) indicative of a location of an individual 2, 51 or 52 and instructions to navigate to the individual 2, 51 or 52 to provide a container 9a-c. The at least one device can be at least one of an AMR 8a-c respectively transporting a container 9a-c or an AMR 8a-c integrated with a respective container 9a-c. The containers 9a-c can include, but are not limited to, a cart, a basket, a bin, a platform truck, a hand truck, and a dolly. For example, the AMRs 8a-c can respectively include containers 9a-c positioned on a top portion of the AMRs 8a-c. The system can generate and transmit a notification to at least one AMR 8a-c to assist an individual 2, 51 or 52 when an individual 2, 51 or 52 may require a container 9a-c to shop if he/she forgot to or could not procure a container 4 prior to shopping and cannot manually carry one or more selected objects 104 (e.g., due to a weight of an object 104 or an aggregate weight of objects 104). The system can also generate and transmit a notification to at least one AMR 8a-c to assist an individual 2, 51 or 52 when an individual 2, 51 or 52 may require a container 9a-c to shop if a container 4 is full and/or too heavy to tow or push. Additionally, the system can determine an appropriate container 9a-c to transport based on a current container 4. For example, if the system detects a basket, the system can generate and transmit a notification to an AMR 8a-c to navigate to the individual with a cart.

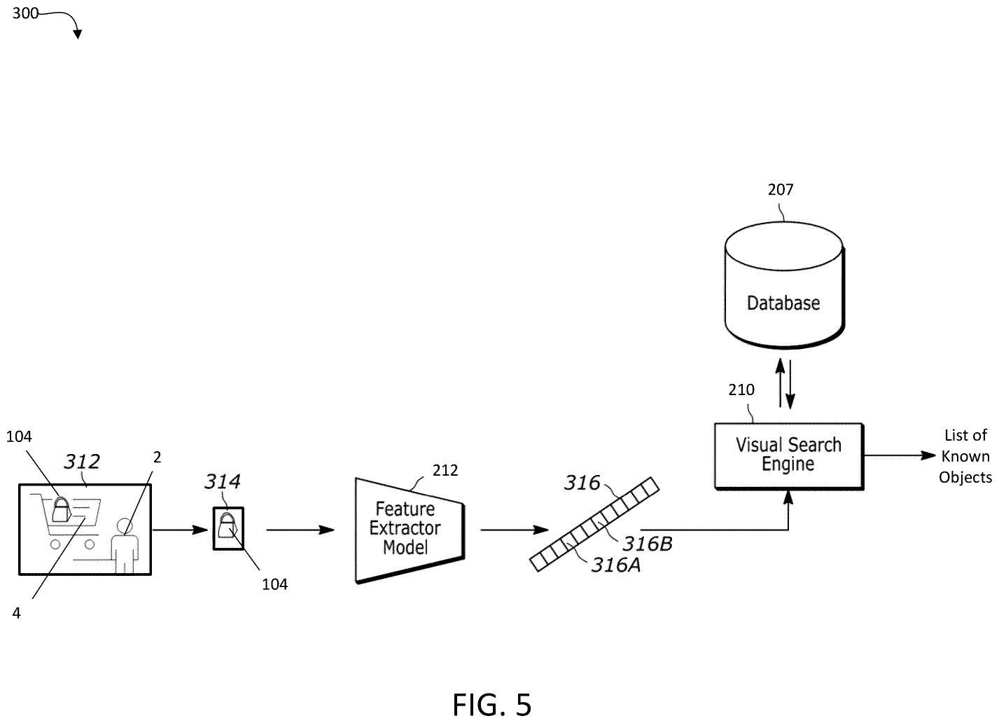

FIG. 5 is a diagram 300 illustrating processing steps 258 and 260 of FIG. 4. As shown in FIG. 5, an imaging assembly 30 can capture an image 312 of an object 104 within a container 4 associated with an individual 2. The system can analyze the image 312 and localize the object 104 within the image 312, such that the remainder of the image not including the object 104 (referenced herein as “background noise”) may be removed, resulting in a localized image 314. For example, the feature extractor model 212 may analyze the image 312, detect the object 104, and may crop the background noise to generate the localized image 314.

The feature extractor model 212 can analyze the object 104 within the localized image 314 and generate a descriptor 316 that represents features (e.g., a size, a shape, a color, a height, a width, or a length) of the object 104 within the image 314. The descriptor 316 may be a vector of real numbers that represents the features of the object 104 within the image 314. The feature extractor model 212 may generate each numerical value within the descriptor 316 in a feature-by-feature fashion and/or generate individual vectors for each feature type. The descriptor 316 may correspond to a size of a respective object 104, wherein a numerical value within the descriptor 316 and/or the aggregate numerical values of the descriptor 316 corresponds to the size of the respective object 104. More specifically, the numerical value represented by box 316A may correspond to the size of the respective object 104, and/or the entire descriptor 316 may represent the size of the respective object 104. Similarly, the descriptor 316 may include and/or otherwise fully correspond to a shape of the respective object 104, such that a different numerical value within the descriptor 316 (e.g., represented by box 316B) and/or the aggregate numerical values of the descriptor 316 corresponds to the shape of the respective object 104. Thus, the feature extractor model 212 may output one or more descriptors 316 corresponding to one or more features of each respective object 104 present in a respective localized image 314.

The feature extractor model 212 may output the descriptor 316 based on training using a plurality of training object images as input. The feature extractor model 212 may be a convolutional neural network (CNN) trained with a plurality of training object images to output a plurality of training descriptors that represent features of the plurality of training object images.

The visual search engine 210 may analyze the descriptor 316 to identify matching known objects stored in the database 207. As mentioned above, the database 207 can store one or more known object descriptors corresponding to respective image data of one or more known objects. The database 207 can also store, for each known object represented, at least one attribute of each known object including, but not limited to, a known object location, a known object weight, and a known object volume. The visual search engine 210 may analyze the descriptor 316 by comparing the numerical values of the descriptor 316 to corresponding numerical values in other descriptors stored in the database 207 to determine metric distances between the object 104 and respective known objects represented by the respective stored descriptors. The metric distance can represent an overall similarity between two data points, such that when the visual search engine 210 determines the metric distance between descriptors representing features (e.g., a size, a shape, a color, a height, a width, or a length) of two different objects (e.g., the object 104 and a stored known object), the engine 210 may determine a measure of similarity between the two different objects. For example, the visual search engine 210 may compare the numerical values represented by boxes 316A, 316B of descriptor 316 to corresponding values of a known object stored in the database 207 and determine a metric distance between the respective values. If the visual search engine 210 determines a small metric distance between these two sets of values, then the engine 210 may determine that the object 104 and the known object are likely to be the same object. Alternatively, if the visual search engine 212 determines a large metric distance between these two sets of values, then the engine 210 may determine that the object 104 and the known object are not likely to be the same object.

The visual search engine 210 may perform a nearest neighbor search to return a ranked list of known objects that may correspond to the object 104 represented in the localized image 314. The visual search engine 210 may filter the descriptors stored in the database 207 prior to performing the search based on the metadata associated with each descriptor and may thereafter rank the known objects based on the calculated metric distance between the respective descriptors. Based on this reduced set of descriptors stored in the database 207 corresponding to known objects, the visual search engine 210 can determine a metric distance between the descriptor 316 and each descriptor corresponding to a known object and generate a prioritized list of known objects based on the metric distance. The visual search engine 210 can select a known object from the list having a highest ranking such that the known object most likely corresponds to the object 104. In this way, the system can identify an object 104 from image data captured by an imaging assembly 30.

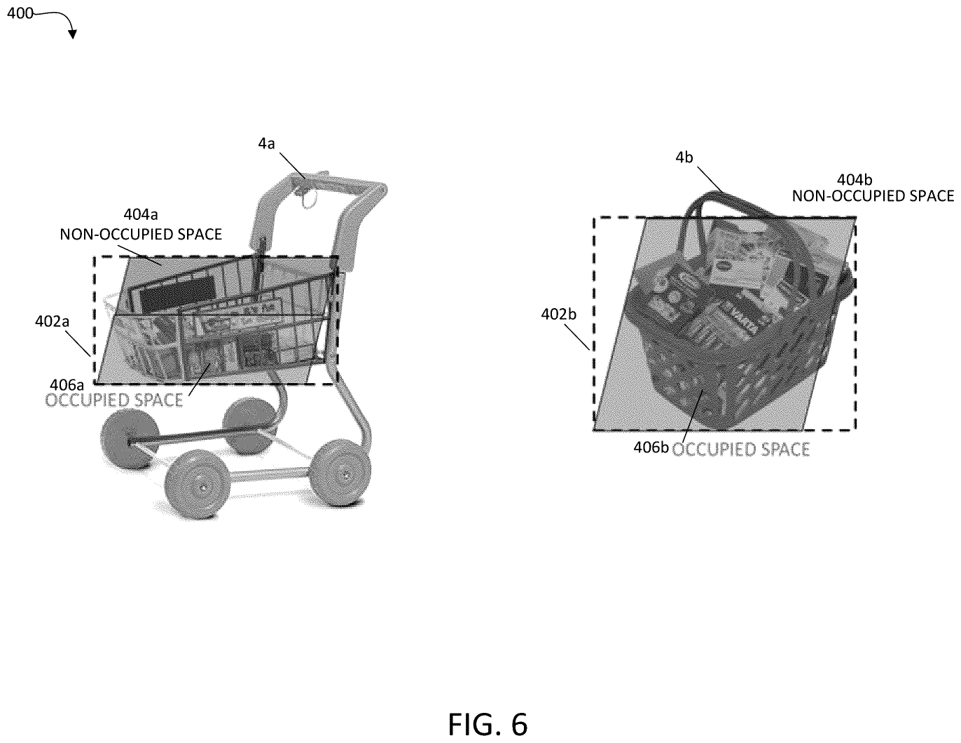

FIG. 6 is a diagram 400 illustrating processing steps 266-272 of FIG. 4. FIG. 6 illustrates a container 4a (e.g., a cart) and a container 4b (e.g., a basket). The container 4a includes a region of interest 402a having a first sub-area 404a indicative of non-occupied space within the container 4a and a second sub-area 406a indicative of occupied space within the container 4a. As shown in FIG. 6, each of the first sub-area 404a and the second sub-area 406a comprise approximately half of the space of the container 4a. As mentioned above, the system can determine whether a ratio of the first sub-area 404a to the second sub-area 406a is less than a threshold. In this way, the system can determine whether an individual 2 requires an additional container 4 based on an availability of space in the container 4a.

The container 4b includes a region of interest 402b having a first sub-area 404b indicative of non-occupied space within the container 4b and a second sub-area 406b indicative of occupied space within the container 4b. As shown in FIG. 6, the second sub-area 406b comprises the space of the container 4b. As mentioned above, the system can determine whether a ratio of the first sub-area 404b to the second sub-area 406b is less than a threshold. In this way, the system can determine whether an individual 2 requires an additional container 4 based on an availability of space in the container 4b. If the system determines that the ratio of the first sub-area 404b to the second sub-area 406b is less than the threshold, then the system generates and transmits a notification to a device (e.g., AMRs 8a-c) indicative of a location of the individual 2 and instructions to navigate to the individual 2 with an additional container (e.g., containers 9a-c).

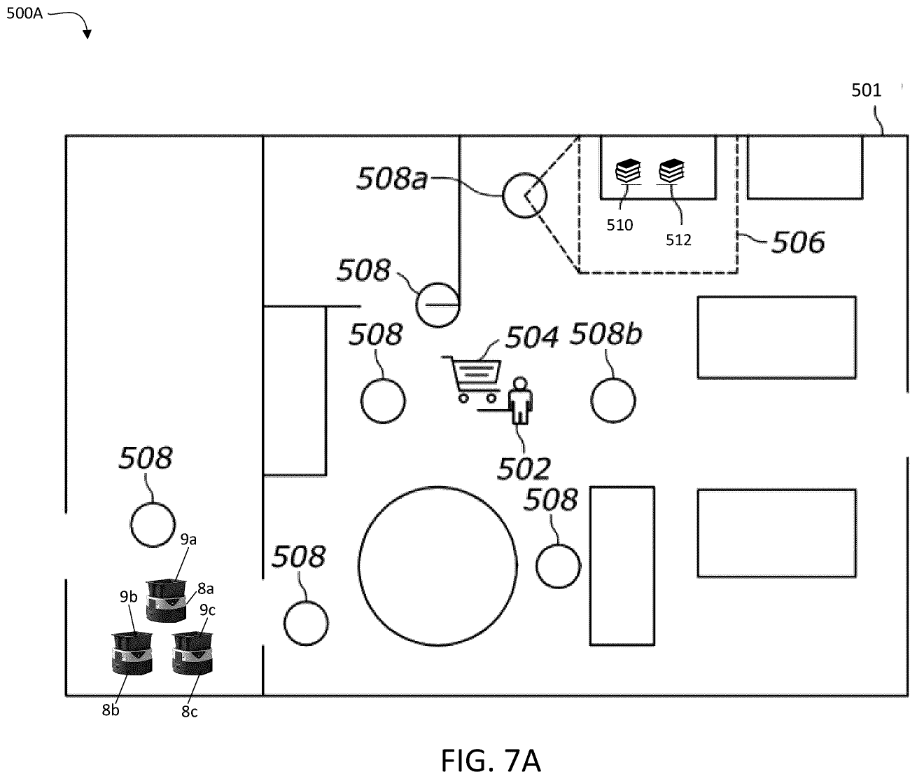

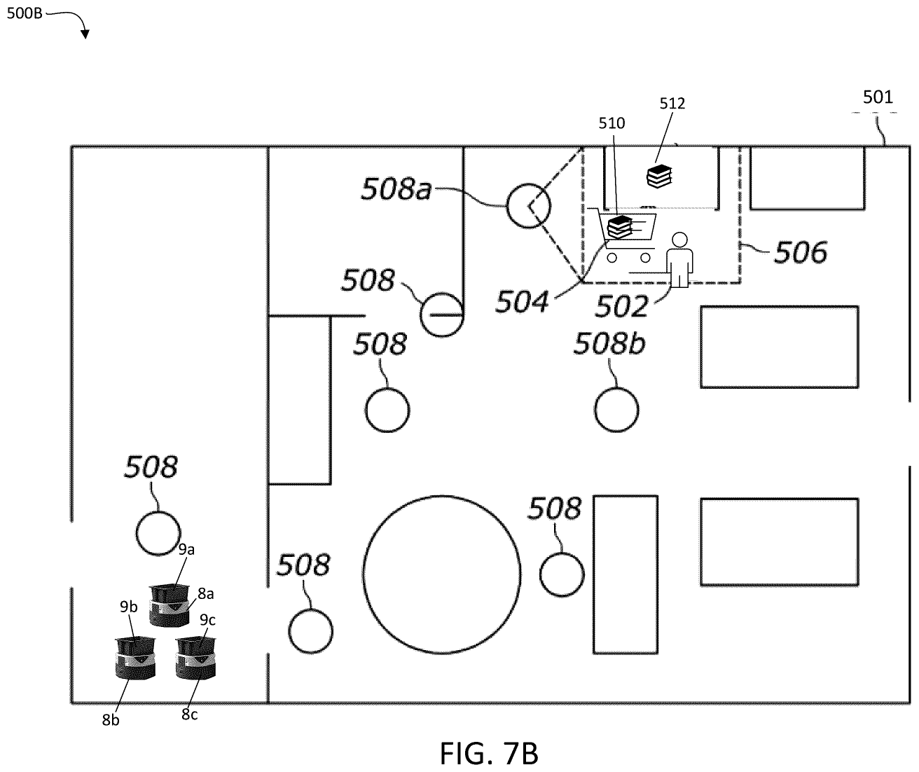

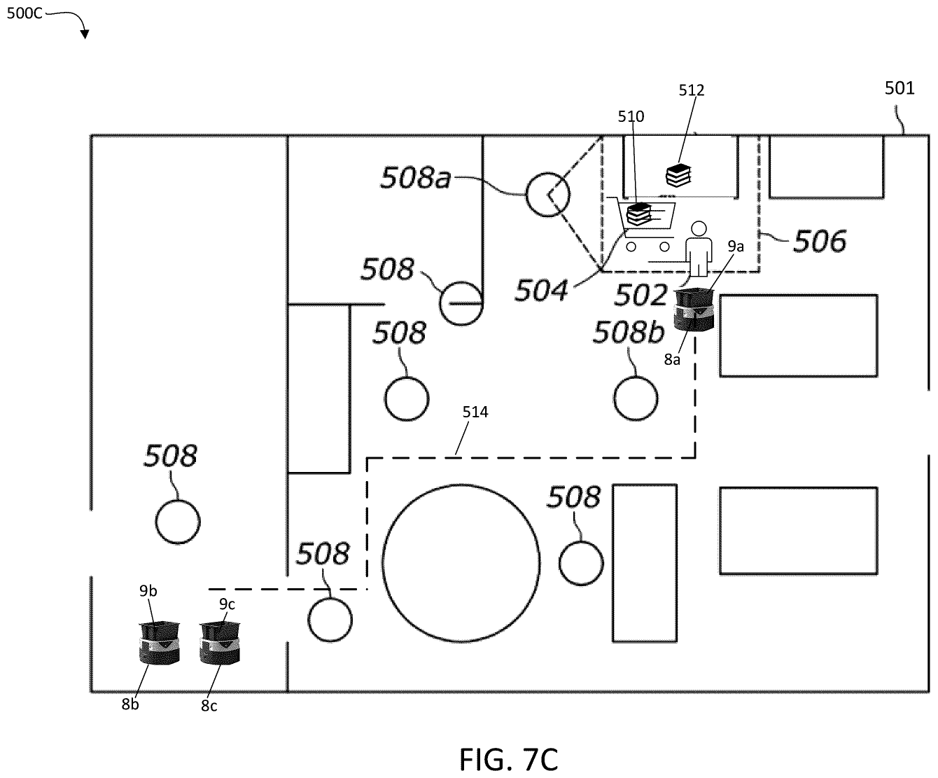

FIGS. 7A-C are respective diagrams 500A-C illustrating an embodiment of the present disclosure. FIGS. 7A-C illustrate a venue in the form of a sales floor 501 in which an individual 502 moves with an associated container 504 (e.g., a cart), from one area to a zone 506 that is within a FOV of an imaging assembly 508a (other imaging assemblies 508 are positioned to image other areas/zones of the venue). The zone 506 may be a zone identified by a supervisor or a central controller 16.

As shown in FIG. 7A, two objects in the form of stacked books 510, 512 are positioned in the zone 506 within a FOV of the imaging assembly 508a and the individual 502 and associated container 504 are not positioned within the zone 506. As shown in FIG. 7B, the individual 502 and associated container 504 move within the zone 506. The imaging assemblies 508 (including imaging assembly 508a) track a movement and/or location of the individual 502 through the sales floor 501. Additionally, the individual 502 collects the stacked books 510 by positioning the stacked books 510 in the container 504. The imaging assembly 508a captures image data of the zone 506 including the stacked books 510 within the container 504 and communicates the image data to a central controller (not shown) for analysis including detecting at least one of the container 504 or the stacked books 510 within the container 504, identifying the stacked books 510, and determining, based on the identification of the stacked books 510, a value (e.g., an integer) of at least one attribute (e.g., a weight) of the stacked books 510.

As shown in FIG. 7C, the system determines, based on the analysis, that the value of the weight of the stacked books 510 is greater than a threshold and generates and transmits a notification to an AMR 8a, having a container 9a, indicative of a location of the individual 502 and instructions to navigate to the individual 502. In this way, the system can facilitate an experience of the individual 502 by providing a container 9a to the individual 502 because the weight of the stacked books 510 is greater than the threshold thereby impeding an ability of the individual 502 to push or tow the container 502. For example, the individual 502 can distribute a weight of the stacked books 510 between the container 504 and the container 9a thereby facilitating an ability of the individual 502 to push or tow the container 502.

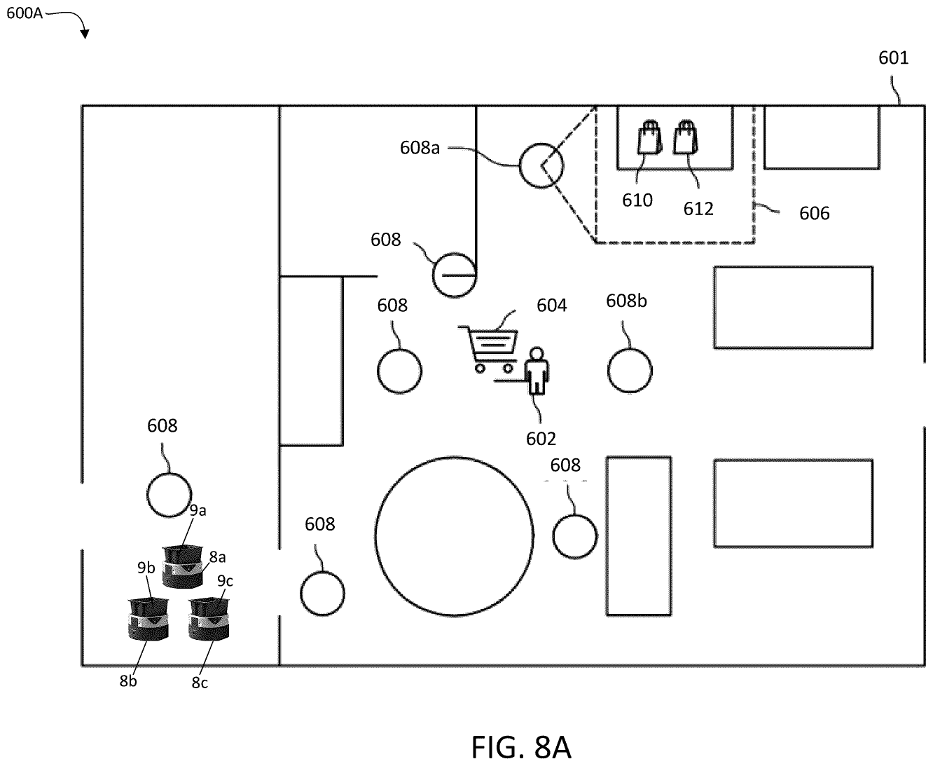

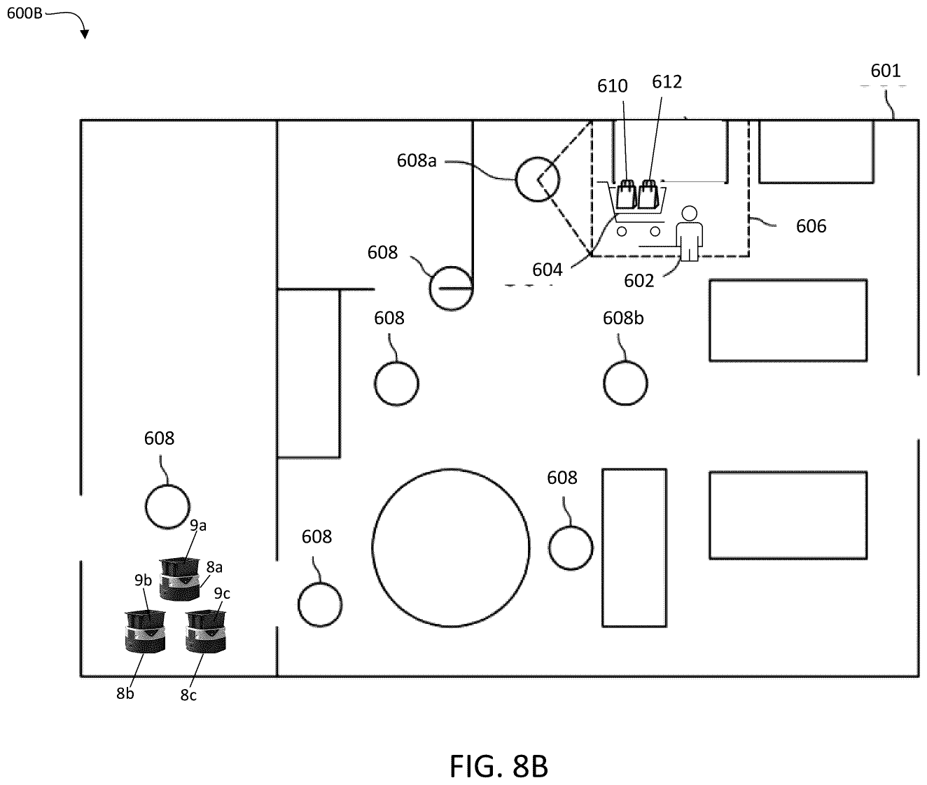

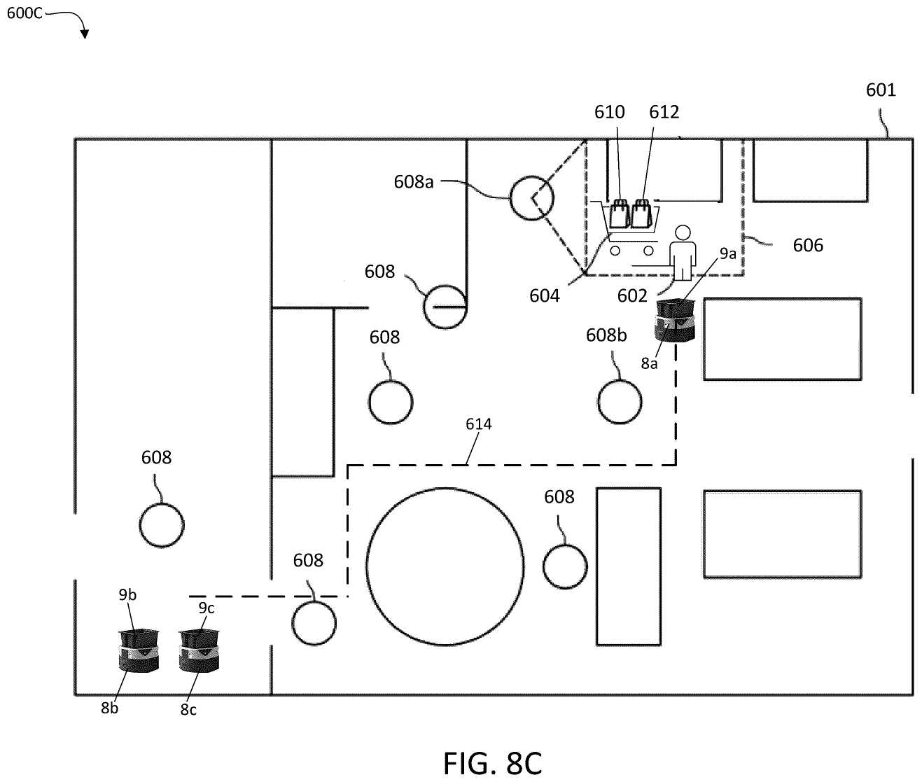

FIGS. 8A-C are respective diagrams 600A-C illustrating another embodiment of the present disclosure. FIGS. 8A-C illustrate a venue in the form of a sales floor 601 in which an individual 602 moves with an associated container 604 (e.g., a cart), from one area to a zone 606 that is within a FOV of an imaging assembly 608a (other imaging assemblies 608 are positioned to image other areas/zones of the venue). The zone 606 may be a zone identified by a supervisor or a central controller 16.

As shown in FIG. 8A, two objects in the form of handbags 610, 612 are positioned in the zone 606 within a FOV of the imaging assembly 608a and the individual 602 and associated container 604 are not positioned within the zone 606. As shown in FIG. 8B, the individual 602 and associated container 604 move within the zone 606. The imaging assemblies 608 (including imaging assembly 608a) track a movement and/or location of the individual 602 through the sales floor 601. Additionally, the individual 602 collects the handbags 610, 612 by positioning the handbags 610, 612 in the container 504. The imaging assembly 608a captures image data of the zone 606 including the handbags 610, 612 within the container 604 and communicates the image data to a central controller (not shown) for analysis including detecting at least one of the container 604 or the handbags 610, 612 within the container 604, identifying each of the handbags 610, 612, and determining, based on the identification of the handbags 610, 612, a value (e.g., an integer) of at least one attribute (e.g., a weight) of each of the handbags 610, 612. Additionally or alternatively, the imaging assembly 608a captures image data of the zone 606 including the handbags 610, 612 within the container 604 and communicates the image data to a central controller (not shown) for analysis including detecting the container 604, identifying a region of interest of the container 604, and determining, based on the identification of the region of interest of the container 604, a first sub-area indicative of non-occupied space within the container 604 and a second sub-area indicative of occupied space within the container 604.

As shown in FIG. 8C, the system determines, based on the analysis, that the value of the weight of the handbags 610, 612 is less than a threshold but that a ratio of the first sub-area to the second sub-area of the container 604 is less than a threshold (e.g., there is insufficient non-occupied space within the container 604 and/or the container 604 is full). As such, the system generates and transmits a notification to an AMR 8a, having a container 9a, indicative of a location of the individual 602 and instructions to navigate to the individual 602. In this way, the system can facilitate an experience of the individual 602 by providing a container 9a to the individual 602 because the ratio of the first sub-area to the second sub-area of the container 604 is less than a threshold (e.g., there is insufficient non-occupied space within the container 604 and/or the container 604 is full) thereby impeding an ability of the individual 602 to add additional objects to the container 602. For example, the individual 602 can distribute the handbags 610, 612 between the container 604 and the container 9a to allow for additional objects to be positioned within the container 602.

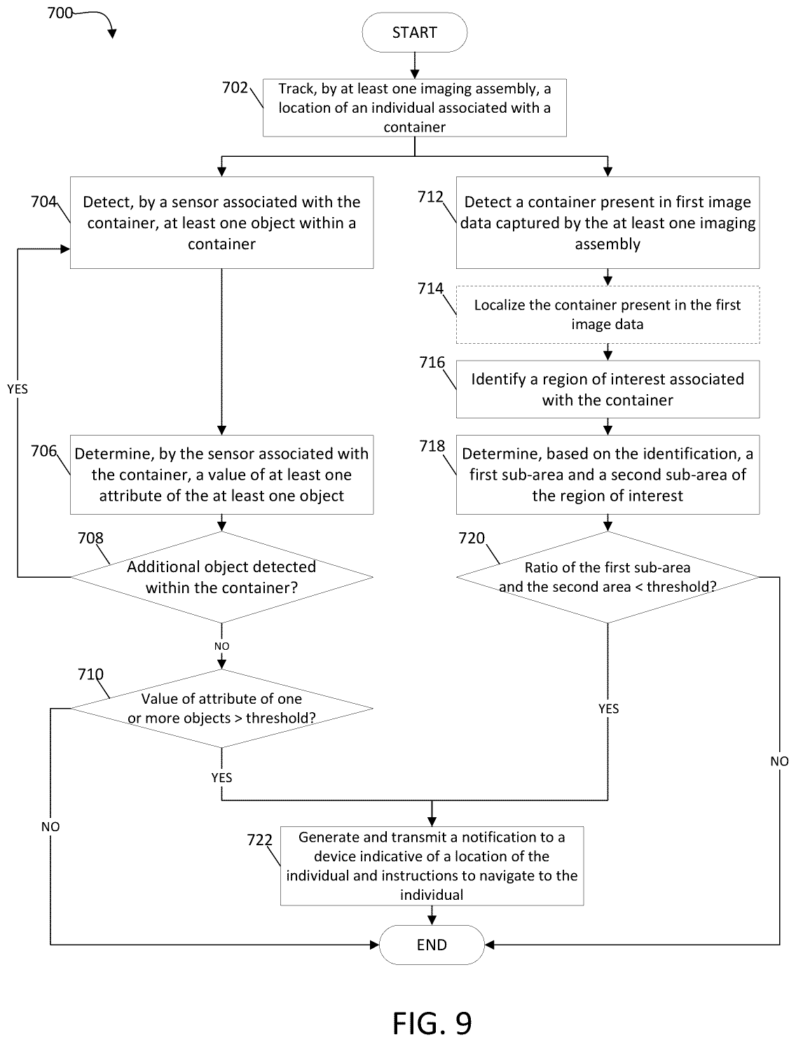

FIG. 9 is a flowchart 700 illustrating processing steps of another embodiment of the present disclosure. Beginning in step 702, the system tracks, by at least one imaging assembly 30, a location of an individual 2 associated with a container 4. The at least one imaging assembly 30 is disposed within a venue 100 and is configured to capture image data over at least a portion of a zone within the venue 100. The container 4 can include, but is not limited to, a cart, a basket, a bin, a platform truck, a hand truck and a dolly. Additionally, the container 4 can include a sensor 6 (e.g., a load cell or scale) having an LED 7.

The process then proceeds to steps 704-710 or steps 712-720. It should be understood that the system can also execute steps 704-710 and steps 712-720 in parallel. Steps 712-720 are similar to steps 266-274 of FIG. 4 and, for brevity, will not be restated.

In step 704, the system detects, by a sensor 6 having an LED 7, at least one object 104 within a container 4. As mentioned above, the sensor 6 is associated with a container 4 (e.g., affixed to a bottom of a container 4) and can be, but is not limited to, a load cell or a scale. The network switch 18 may be configured to operate via wireless, direct, or networked communication with the sensor 6, where the sensor 6 may transmit and receive wireless electronic communication to and from the network switch 18. The sensor 6 may also be in wireless communication with computer systems 116 and 136. Similarly, the sensor 6 may be in wireless electronic communication with the centralized controller 16 via the network switch 18. The sensor 6 may transmit and receive wireless electronic communication using built-in wireless transceivers and may use the IEEE 802.11 (WiFi) and/or Bluetooth standards for wireless communications.

In step 706, the system determines, via the sensor 6, a value of at least one attribute (e.g., a weight) of the at least one object 104 within the container 4. As such, the system can determine, for example, a weight of the at least one object 104.

The process then proceeds to step 708. In step 708, the system determines whether an additional object 104 is detected by the sensor 6 within the container 4. If the system determines that an additional object 104 is detected within the container 4, then the process returns to step 704. If the system determines that an additional object 104 is not detected within the container 4, then the process proceeds to step 710. In step 710, the system determines whether a value of an attribute of one or more objects 104 is greater than a threshold. In this way, the system can determine whether an individual 2 requires an additional container (e.g., containers 9a-c) based on a weight of an object 104 or an aggregate weight of objects 104 within a current container 4. If the system determines that a value of an attribute of one or more objects 104 is greater than a threshold, then the process proceeds to step 722 (discussed in further detail below). For example, the system can determine that an aggregate weight of one or more objects 104 is greater than a threshold. Alternatively, if the system determines that a value of an attribute of one or more objects 104 is less than a threshold, then the process ends. For example, the system can determine that an aggregate weight of one or more objects 104 is less than a threshold.

In an embodiment, the sensor 6 can activate the LED 7 when the system determines that a value of an attribute of one or more objects 104 is greater than a threshold (e.g., that an aggregate weight of one or more objects 104 is greater than a threshold) and an imaging assembly 30 can detect the activated LED 7. The system, based on the detected activated LED 7, can validate (e.g., confirm) that a value of an attribute of one or more objects 104 is greater than a threshold. In another embodiment, the sensor 6 may be an air-gapped (e.g., a non-networked) sensor. As such, the system can determine, based on the detected activated LED 7, that a value of an attribute of one or more objects 104 is greater than a threshold. Alternatively, the system can determine, based on a non-activated LED 7, that a value of an attribute of one or more objects 104 is not greater than a threshold.

In step 722, the system generates and transmits a notification to at least one device (e.g., AMRs 8a-c) indicative of a location of an individual 2, 51 or 52 and instructions to navigate to the individual 2, 51 or 52 to provide a container 9a-c. The at least one device can be at least one of an AMR 8a-c respectively transporting a container 9a-c or an AMR 8a-c integrated with a respective container 9a-c. The containers 9a-c can include, but are not limited to, a cart, a basket, a bin, a platform truck, a hand truck, and a dolly. For example, the AMRs 8a-c can respectively include containers 9a-c positioned on a top portion of the AMRs 8a-c. The system can generate and transmit a notification to at least one AMR 8a-c to assist an individual 2, 51 or 52 when an individual 2, 51 or 52 may require a container 9a-c to shop if he/she forgot to or could not procure a container 4 prior to shopping and cannot manually carry one or more selected objects 104 (e.g., due to a weight of an object 104 or an aggregate weight of objects 104). The system can also generate and transmit a notification to at least one AMR 8a-c to assist an individual 2, 51 or 52 when an individual 2, 51 or 52 may require a container 9a-c to shop if a container 4 is full and/or too heavy to tow or push. Additionally, the system can determine an appropriate container 9a-c to transport based on a current container 4. For example, if the system detects a basket, the system can generate and transmit a notification to an AMR 8a-c to navigate to the individual with a cart.

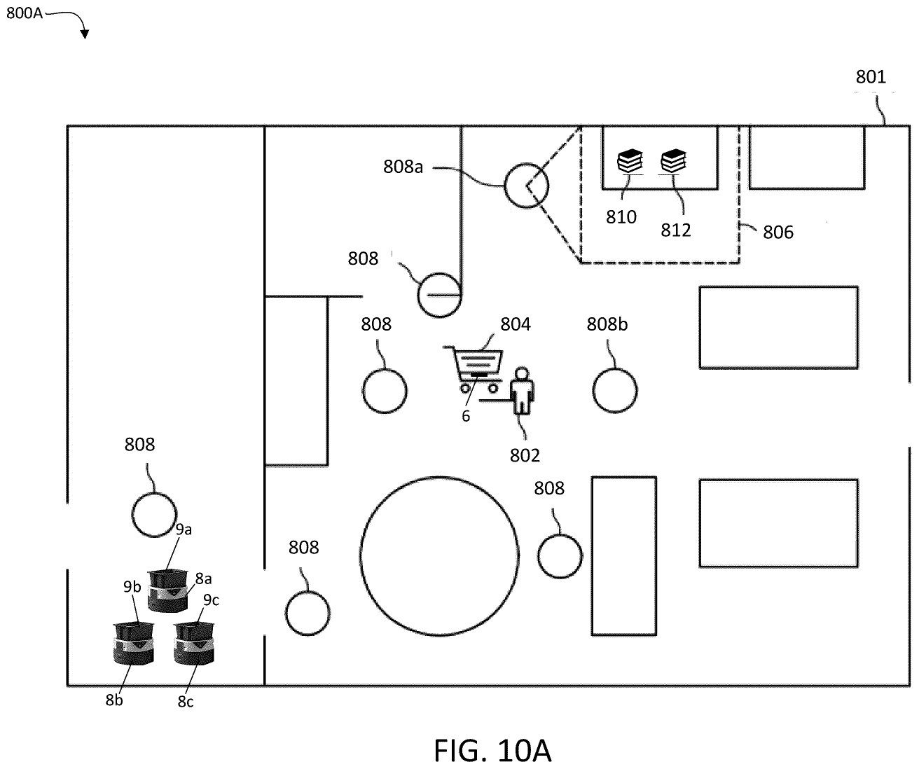

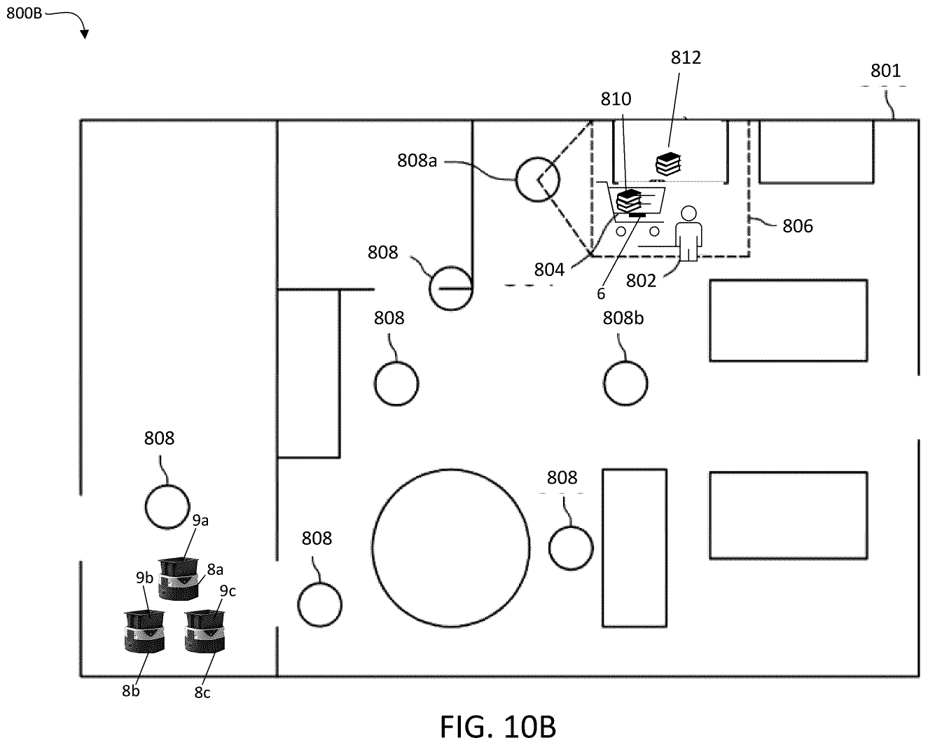

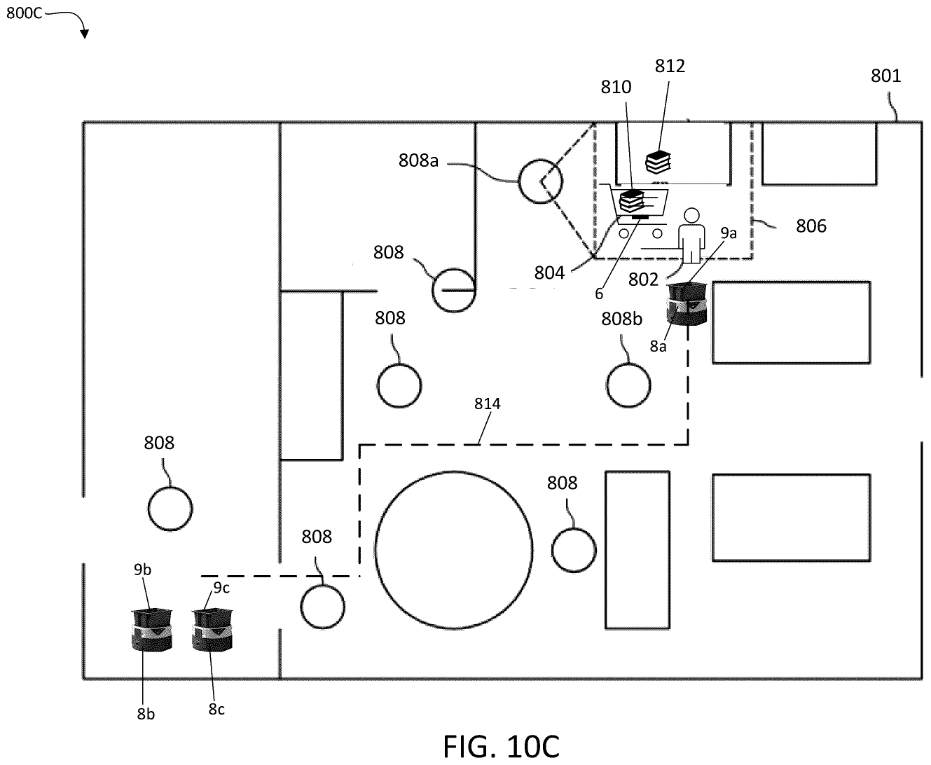

FIGS. 10A-C are diagrams 800A-C illustrating another embodiment of the present disclosure. FIGS. 10A-C illustrate a venue in the form of a sales floor 801 in which an individual 802 moves with an associated container 804 (e.g., a cart) having a sensor 6, from one area to a zone 806 that is within a FOV of an imaging assembly 808a (other imaging assemblies 808 are positioned to image other areas/zones of the venue). The zone 806 may be a zone identified by a supervisor or a central controller 16.

As shown in FIG. 10A, two objects in the form of stacked books 810, 812 are positioned in the zone 806 within a FOV of the imaging assembly 808a and the individual 802 and associated container 804 are not positioned within the zone 806. As shown in FIG. 10B, the individual 802 and associated container 804 move within the zone 806. The imaging assemblies 808 (including imaging assembly 808a) track a movement and/or location of the individual 802 through the sales floor 801. Additionally, the individual 802 collects the stacked books 810 by positioning the stacked books 810 in the container 804. The sensor 6 detects the stacked books 810 within the container 804. As mentioned above, the sensor 6 is associated with the container 804 (e.g., affixed to a bottom of a container 804) and can be, but is not limited to, a load cell or a scale. The sensor 6 determines a value (e.g., an integer) of at least one attribute (e.g., a weight) of the stacked books 810 within the container 804. As such, the system can determine, for example, a weight of the stacked books 812.

As shown in FIG. 10C, the system determines that the value of the weight of the stacked books 810 is greater than a threshold and generates and transmits a notification to an AMR 8a, having a container 9a, indicative of a location of the individual 802 and instructions to navigate to the individual 802. In this way, the system can facilitate an experience of the individual 802 by providing a container 9a to the individual 802 because the weight of the stacked books 810 is greater than the threshold thereby impeding an ability of the individual 802 to push or tow the container 802. For example, the individual 802 can distribute a weight of the stacked books 810 between the container 804 and the container 9a thereby facilitating an ability of the individual 802 to push or tow the container 802.

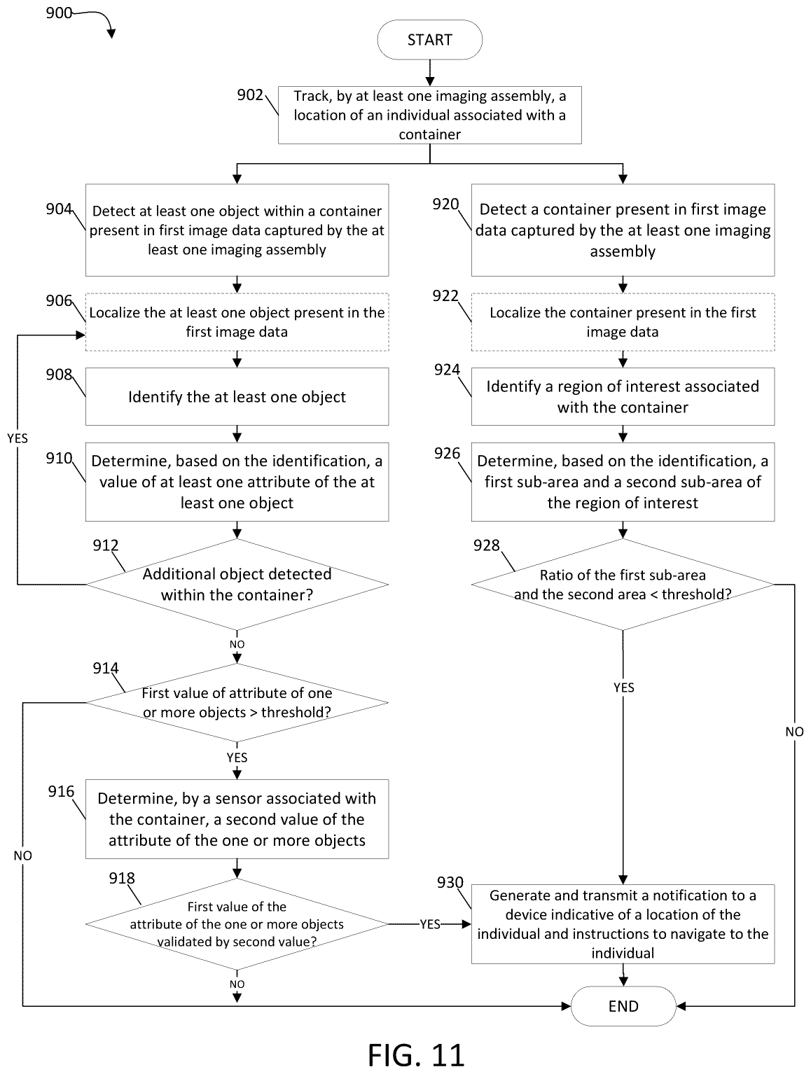

FIG. 11 is a flowchart illustrating another embodiment of the present disclosure. Beginning in step 902, the system tracks, by at least one imaging assembly 30, a location of an individual 2 associated with a container 4. The at least one imaging assembly 30 is disposed within a venue 100 and is configured to capture image data over at least a portion of a zone within the venue 100. The container 4 can include, but is not limited to, a cart, a basket, a bin, a platform truck, a hand truck and a dolly. Additionally, the container 4 can include a sensor 6 (e.g., a load cell or scale) having an LED 7.

The process then proceeds to steps 904-914 or steps 920-928. It should be understood that the system can also execute steps 904-914 and steps 920-928 in parallel. Steps 904-912 are similar to steps 254-262 of FIG. 4 and steps 920-928 are similar to steps 266-274 of FIG. 4 and, for brevity, will not be restated.

Beginning in step 914, the system determines whether a first value (e.g., an integer) of an attribute (e.g., weight) of one or more objects 104 is greater than a threshold. If the system determines that a first value of an attribute of one or more objects 104 is greater than a threshold, then the process proceeds to step 916. For example, the system can determine that an aggregate weight of one or more objects 104 is greater than a threshold. Alternatively, if the system determines that a first value of an attribute of one or more objects 104 is less than a threshold, then the process ends. For example, if the system determines that an aggregate weight of one or more objects 104 is less than a threshold, then the process ends.

In step 916, the system determines a second value (e.g., an integer) of the attribute (e.g., weight) of the one or more objects 104 within the container 4 via a sensor 6 associated with the container 4 (e.g., affixed to a bottom of a container 4) where the sensor 6 can be, but is not limited to, a load cell or a scale. As such, the system can determine, for example, a weight of an object 104 or an aggregate weight of objects 104 within a container 4. In step 918, the system determines whether the first value of the attribute of the one or more objects 104 determined by the machine vision and/or machine learning techniques (e.g., the visual search engine 210 and feature extractor model 212) is validated by the second value of the attribute of the one or more object 104 determined by the sensor 6. If the system determines that the first value is validated by the second value, then the process proceeds to step 930. Alternatively, if the system determines that the first value is not validated by the second value, then the process ends. In this way, the system can determine and verify that an individual 2 requires an additional container (e.g., containers 9a-c) based on a weight of an object 104 or an aggregate weight of objects 104 within a current container 4.

In step 930, the system generates and transmits a notification to at least one device (e.g., AMRs 8a-c) indicative of a location of an individual 2, 51 or 52 and instructions to navigate to the individual 2, 51 or 52 to provide a container 9a-c. The at least one device can be at least one of an AMR 8a-c respectively transporting a container 9a-c or an AMR 8a-c integrated with a respective container 9a-c. The containers 9a-c can include, but are not limited to, a cart, a basket, a bin, a platform truck, a hand truck, and a dolly. For example, the AMRs 8a-c can respectively include containers 9a-c positioned on a top portion of the AMRs 8a-c. The system can generate and transmit a notification to at least one AMR 8a-c to assist an individual 2, 51 or 52 when an individual 2, 51 or 52 may require a container 9a-c to shop if he/she forgot to or could not procure a container 4 prior to shopping and cannot manually carry one or more selected objects 104 (e.g., due to a weight of an object 104 or an aggregate weight of objects 104). The system can also generate and transmit a notification to at least one AMR 8a-c to assist an individual 2, 51 or 52 when an individual 2, 51 or 52 may require a container 9a-c to shop if a container 4 is full and/or too heavy to tow or push. Additionally, the system can determine an appropriate container 9a-c to transport based on a current container 4. For example, if the system detects a basket, the system can generate and transmit a notification to an AMR 8a-c to navigate to the individual with a cart.

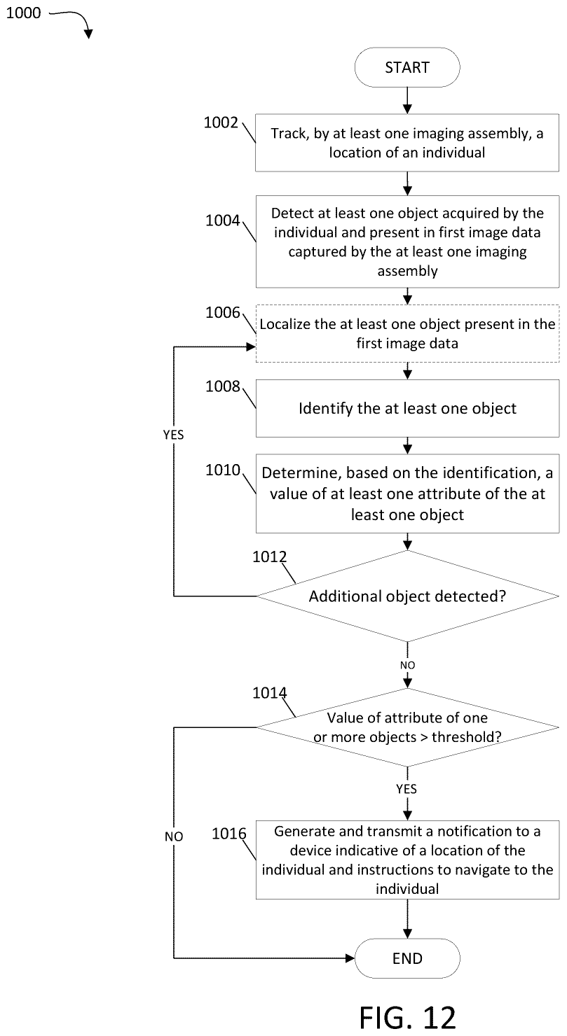

FIG. 12 is a flowchart illustrating another embodiment of the present disclosure. Beginning in step 1002, the system tracks, by at least one imaging assembly 30, a location of an individual 2. The at least one imaging assembly 30 is disposed within a venue 100 and is configured to capture image data over at least a portion of a zone within the venue 100. Then, in step 1004, the system detects at least one object 104 acquired by the individual 2 and present in first image data captured by the at least one imaging assembly 30. For example, the system detects at least one object 104 manually carried by the individual 2. The process then proceeds to steps 1006-1014. Steps 1006-1014 are similar to steps 256-264 of FIG. 4 and, for brevity, will not be restated.

In step 1016, the system generates and transmits a notification to at least one device (e.g., AMRs 8a-c) indicative of a location of an individual 2, 51 or 52 and instructions to navigate to the individual 2, 51 or 52 to provide a container 9a-c. The at least one device can be at least one of an AMR 8a-c respectively transporting a container 9a-c or an AMR 8a-c integrated with a respective container 9a-c. The containers 9a-c can include, but are not limited to, a cart, a basket, a bin, a platform truck, a hand truck, and a dolly. For example, the AMRs 8a-c can respectively include containers 9a-c positioned on a top portion of the AMRs 8a-c. The system can generate and transmit a notification to at least one AMR 8a-c to assist an individual 2, 51 or 52 when an individual 2, 51 or 52 may require a container 9a-c to shop if he/she forgot to or could not procure a container 4 prior to shopping and cannot manually carry one or more selected objects 104 (e.g., due to a weight of an object 104 or an aggregate weight of objects 104). Additionally, the system can determine an appropriate container 9a-c to transport based on an identification of one or more objects 104. For example, if the system detects several large and heavy objects 104 carried by the individual 2, the system can generate and transmit a notification to an AMR 8a-c to navigate to the individual with a cart.

In the foregoing specification, the above description refers to one or more block diagrams of the accompanying drawings. Alternative implementations of the examples represented by the block diagrams includes one or more additional or alternative elements, processes and/or devices. Additionally or alternatively, one or more of the example blocks of the diagrams may be combined, divided, re-arranged or omitted. Components represented by the blocks of the diagrams are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method comprising:
tracking, by at least one imaging assembly, a location of an individual associated with a container;
detecting at least one of the container or at least one object within the container present in first image data captured by the at least one imaging assembly;
identifying at least one of the at least one object or a region of interest associated with the container;
determining, based on the identification, at least one of a value of at least one attribute of the at least one object or a first sub-area and a second sub-area of the region of interest;
determining whether at least one of the value of the at least one attribute is greater than a first threshold or a ratio of the first sub-area and the second sub-area is less than a second threshold; and
generating and transmitting a notification to a device when at least one of the value of the at least one attribute is greater than the first threshold or the ratio of the first sub-area and the second sub-area is less than the second threshold, the notification being indicative of the location of the individual and instructions to the device to navigate to the individual based on the location.

2. The method of claim 1, wherein
the at least one imaging assembly is disposed within a venue and is configured to capture the first image data over at least a portion of a zone within the venue,
the container is at least one of a cart, a basket, a bin, a platform truck, a hand truck, or a dolly, and
the device is at least one of an autonomous mobile robot (AMR) transporting a container or an AMR integrated with a container.

3. The method of claim 1, wherein
the at least one attribute of the at least one object is a weight of the at least one object, and
the first sub-area is indicative of non-occupied space within the container and the second sub-area is indicative of occupied space within the container.

4. The method of claim 1, further comprising localizing at least one of the detected container or the detected at least one object by removing background noise from the first image data.

5. The method of claim 1, wherein identifying the at least one object comprises:
generating, by applying a feature extractor model to the first image data, at least one object descriptor indicative of one or more features of the detected at least one object;
executing, by a visual search engine, a nearest neighbor search within a database storing one or more known object descriptors corresponding to respective image data of one or more known objects to determine a respective metric distance between the at least one object descriptor and the one or more known object descriptors; and
selecting, by the visual search engine, a known object corresponding to the detected at least one object from a ranked list of known objects, the ranked list of known objects being prioritized based on a respective metric distance between the at least one object descriptor and the one or more known object descriptors.

6. The method of claim 5, wherein the feature extractor model is a machine learning model comprising a convolutional neural network classifier or visual transformer classifier trained on one or more of supervised learning tasks or unsupervised learning tasks.

7. The method of claim 5, wherein for each known object represented in the database, the database stores at least one attribute of the known object including one or more of (i) a known object location, (ii) a known object weight, or (iii) a known object volume.

8. The method of claim 5, wherein
the at least one object descriptor and the one or more known object descriptors are indicative of one or more features comprising one or more of a shape, a color, a height, a width, or a length, and
the at least one object descriptor and the one or more known object descriptors correspond to vectors and the respective metric distance between the at least one object descriptor and the one or more known object descriptors corresponds to differences between respective vectors of the at least one object descriptor and the one or more known object descriptors.

9. A system comprising:
at least one imaging assembly;
a server communicatively coupled to the at least one imaging assembly; and
computing instructions stored on a memory accessible by the server, and that when executed by one or more processors communicatively connected to the server, cause the one or more processors to:
track, by the at least one imaging assembly, a location of an individual associated with a container,
detect at least one of the container or at least one object within the container present in first image data captured by the at least one imaging assembly,
identify at least one of the at least one object or a region of interest associated with the container,
determine, based on the identification, at least one of a value of at least one attribute of the at least one object or a first sub-area and a second sub-area of the region of interest,
determine whether at least one of the value of the at least one attribute is greater than a first threshold or a ratio of the first sub-area and the second sub-area is less than a second threshold, and
generate and transmit a notification to a device when at least one of the value of the at least one attribute is greater than the first threshold or the ratio of the first sub-area and the second sub-area is less than the second threshold, the notification being indicative of the location of the individual and instructions to the device to navigate to the individual based on the location.

10. The system of claim 9, wherein
the at least one imaging assembly is disposed within a venue and is configured to capture the first image data over at least a portion of a zone within the venue,
the container is at least one of a cart, a basket, a bin, a platform truck, a hand truck, or a dolly, and
the device is at least one of an autonomous mobile robot (AMR) transporting a container or an AMR integrated with a container.

11. The system of claim 9, wherein
the at least one attribute of the at least one object is a weight of the at least one object, and
the first sub-area is indicative of non-occupied space within the container and the second sub-area is indicative of occupied space within the container.

12. The system of claim 9, wherein the computing instructions, when executed by the one or more processors communicatively connected to the server, further cause the one or more processors to localize at least one of the detected container or the detected at least one object by removing background noise from the first image data.

13. The system of claim 9, wherein identifying the at least one object comprises:
generating, by applying a feature extractor model to the first image data, at least one object descriptor indicative of one or more features of the detected at least one object,
executing, by a visual search engine, a nearest neighbor search within a database storing one or more known object descriptors corresponding to respective image data of one or more known objects to determine a respective metric distance between the at least one object descriptor and the one or more known object descriptors, and
selecting, by the visual search engine, a known object corresponding to the detected at least one object from a ranked list of known objects, the ranked list of known objects being prioritized based on a respective metric distance between the at least one object descriptor and the one or more known object descriptors.

14. The system of claim 13, wherein the feature extractor model is a machine learning model comprising a convolutional neural network classifier or visual transformer classifier trained on one or more of supervised learning tasks or unsupervised learning tasks.

15. The system of claim 13, wherein for each known object represented in the database, the database stores at least one attribute of the known object including one or more of (i) a known object location, (ii) a known object weight, and (iii) a known object volume.

16. The system of claim 13, wherein
the at least one object descriptor and the one or more known object descriptors are indicative of one or more features comprising one or more of a shape, a color, a height, a width, and a length, and
the at least one object descriptor and the one or more known object descriptors correspond to vectors and the respective metric distance between the at least one object descriptor and the one or more known object descriptors corresponds to differences between respective vectors of the at least one object descriptor and the one or more known object descriptors.

17. A tangible, non-transitory computer-readable medium storing instructions, that when executed by one or more processors, cause the one or more processors to:
track, by at least one imaging assembly, a location of an individual associated with a container;
detect at least one of the container or at least one object within the container present in first image data captured by the at least one imaging assembly;
identify at least one of the at least one object or a region of interest associated with the container;
determine, based on the identification, at least one of a value of at least one attribute of the at least one object or a first sub-area and a second sub-area of the region of interest;
determine whether at least one of the value of the at least one attribute is greater than a first threshold or a ratio of the first sub-area and the second sub-area is less than a second threshold; and
generate and transmit a notification to a device when at least one of the value of the at least one attribute is greater than the first threshold or the ratio of the first sub-area and the second sub-area is less than the second threshold, the notification being indicative of the location of the individual and instructions to the device to navigate to the individual based on the location.

18. The tangible, non-transitory computer-readable medium of claim 17, wherein
the at least one imaging assembly is disposed within a venue and is configured to capture the first image data over at least a portion of a zone within the venue,
the container is at least one of a cart, a basket, a bin, a platform truck, a hand truck, or a dolly, and
the device is at least one of an autonomous mobile robot (AMR) transporting a container or an AMR integrated with a container.

19. The tangible, non-transitory computer-readable medium of claim 17, wherein
the at least one attribute of the at least one object is a weight of the at least one object, and
the first sub-area is indicative of non-occupied space within the container and the second sub-area is indicative of occupied space within the container.

20. The tangible, non-transitory computer-readable medium of claim 17, wherein the instructions, when executed by the one or more processors, further cause the one or more processors to localize at least one of the detected container or the detected at least one object by removing background noise from the first image data.

21. The tangible, non-transitory computer-readable medium of claim 17, wherein identifying the at least one object comprises:
generating, by applying a feature extractor model to the first image data, at least one object descriptor indicative of one or more features of the detected at least one object,
executing, by a visual search engine, a nearest neighbor search within a database storing one or more known object descriptors corresponding to respective image data of one or more known objects to determine a respective metric distance between the at least one object descriptor and the one or more known object descriptors, and
selecting, by the visual search engine, a known object corresponding to the detected at least one object from a ranked list of known objects, the ranked list of known objects being prioritized based on a respective metric distance between the at least one object descriptor and the one or more known object descriptors.

22. The tangible, non-transitory computer-readable medium of claim 21, wherein the feature extractor model is a machine learning model comprising a convolutional neural network classifier or visual transformer classifier trained on one or more of supervised learning tasks or unsupervised learning tasks.

23. The tangible, non-transitory computer-readable medium of claim 21, wherein for each known object represented in the database, the database stores at least one attribute of the known object including one or more of (i) a known object location, (ii) a known object weight, and (iii) a known object volume.

24. The tangible, non-transitory computer-readable medium of claim 21, wherein
the at least one object descriptor and the one or more known object descriptors are indicative of one or more features comprising one or more of a shape, a color, a height, a width, and a length, and
the at least one object descriptor and the one or more known object descriptors correspond to vectors and the respective metric distance between the at least one object descriptor and the one or more known object descriptors corresponds to differences between respective vectors of the at least one object descriptor and the one or more known object descriptors.
